(19) United States
(12) Patent Application Publication
(10) Pub. No.: US 2025/0356530 A1
(43) Pub. Date: Nov. 20, 2025

(54) IMAGE PROCESSING APPARATUS AND IMAGE PROCESSING METHOD

(71) Applicant: Sony Group Corporation, Tokyo (JP)

(72) Inventors: Hajime MIHARA, Tokyo (JP); Yusuke MORIUCHI, Kanagawa (JP); Takeshi UEMORI, Tokyo (JP); Legong SUN, Tokyo (JP)

(73) Assignee: Sony Group Corporation, Tokyo (JP)

(21) Appl. No.: 18/871,313

(22) PCT Filed: May 29, 2023
(86) PCT No.: PCT/JP2023/019861

§ 371 Date: Dec. 3, 2024

(30) Foreign Application Priority Data
Jun. 17, 2022 (JP) 2022-098026

(51) Int. Cl. G06T 7/90

(52) U.S. Cl. CPC G06T 7/90; G06T 2207/10024; G06T 2207/20081; G06T 2207/20084; G06T 2207/20212

(57) ABSTRACT

To enable separation of an input image into an object color image and a shadow image with a high precision. An image processing apparatus includes an object color estimation unit that estimates an object color image having a color component of an object included in an input image as a pixel value on the basis of a feature amount of the input image, and a shadow estimation unit that estimates a shadow image having a shadow component of the input image as a pixel value on the basis of the feature amount of the input image. The shadow estimation unit estimates the shadow image by limiting a color space that can be taken by the shadow component of the input image to a color space determined under a predetermined color condition. The technology of the present disclosure can be applied to, for example, an image processing apparatus or the like that separates an input image into an object color image and a shadow image.

### TECHNICAL FIELD

The present disclosure relates to an image processing apparatus and an image processing method, and more particularly, to an image processing apparatus and an image processing method capable of separating an input image into an object color image and a shadow image with a high precision.

### CROSS REFERENCE TO RELATED APPLICATIONS

This application claims the benefit of Japanese Priority Patent Application JP 2022-098026 filed on Jun. 17, 2022, the entire contents of which are incorporated herein by reference.

### BACKGROUND ART

There is an intrinsic image decomposition technology of separating an input image into an object color image (also referred to as a reflectance image or the like) and a shadow image. For example, NPL 1 discloses a technology of estimating an object color image and a shadow image by using a convolutional neural network (hereinafter, referred to as CNN). NPL 2 discloses a technology of separating an image into an object color image and a shadow image by estimating the shadow image in grayscale. PTL 1 discloses a method of improving image quality by estimating a completely diffused component of an image, further performing correction to obtain an object color, and then applying a shadow or specularity estimated in the same way to the corrected object color. In PTL 1, since the completely diffused component includes a component of a light source color, spectral information of a subject is estimated on the basis of a CIE daylight model or the like, and then an influence of the light source color is removed from the completely diffused component, thereby restoring the object color. Furthermore, as in PTL 2, there is a technology of performing separation into a moving image of an object color image and a moving image of a shadow image as means for improving a compression rate in encoding a moving image.

### CITATION LIST

### Patent Literature

PTL 1: JP 6004481 B2
PTL 2: U.S. Pat. No. 10,659,787

### Non Patent Literature

NPL 1: Narihira et al., Direct Intrinsics: Learning Albedo-Shading Decomposition by Convolutional Regression, CVPR 2015
NPL 2: Fan et al., Revisiting Deep Intrinsic Image Decompositions, CVPR 2018

### SUMMARY OF INVENTION

### Technical Problem

The intrinsic image decomposition is essentially an ill-posed problem of obtaining two variables, an object color and a shadow, from one input image, and a solution is not uniquely determined. Therefore, in PTL 1, it is assumed that a target object is a face and the color of the target object is generally known, and in NPL 2, the shadow image is estimated in grayscale by assuming only white light. There is still room for improvement in a technology of separating an input image into an object color image and a shadow image, and a technology of performing separation into an object color image and a shadow image with a high precision is expected.

The present disclosure has been made in view of such a situation, and enables separation of an input image into an object color image and a shadow image with a high precision.

### Solution to Problem

An image processing apparatus according to one aspect of the present disclosure includes: an object color estimation unit that estimates an object color image having a color component of an object included in an input image as a pixel value on the basis of a feature amount of the input image; and a shadow estimation unit that estimates a shadow image having a shadow component of the input image as a pixel value on the basis of the feature amount of the input image, in which the shadow estimation unit estimates the shadow image by limiting a color space that is available by the shadow component of the input image to a color space determined under a predetermined color condition.

An image processing method executed by an image processing apparatus according to one aspect of the present disclosure includes: estimating an object color image having a color component of an object included in an input image as a pixel value on the basis of a feature amount of the input image; and
estimating a shadow image having a shadow component of the input image as a pixel value on the basis of the feature amount of the input image, in which the shadow image is estimated by limiting a color space that is available by the shadow component of the input image to a color space determined under a predetermined color condition.

In one aspect of the present disclosure, an object color image having a color component of an object included in an input image as a pixel value is estimated on the basis of a feature amount of the input image, and a shadow image having a shadow component of the input image as a pixel value is estimated on the basis of the feature amount of the input image. The shadow image is estimated by limiting a color space that can be taken by the shadow component of the input image to a color space determined under a predetermined color condition.

Note that the image processing apparatus according to one aspect of the present disclosure can be implemented by causing a computer to execute a program. The program executed by the computer can be provided by being transmitted via a transmission medium or by being recorded on a recording medium.

The image processing apparatus may be an independent apparatus or an internal block included in one apparatus.

### BRIEF DESCRIPTION OF DRAWINGS

FIG. 1 is a block diagram illustrating an example of a configuration of a first embodiment of an image processing apparatus of the present disclosure.

FIG. 2 is a diagram illustrating a black-body radiation locus on an xy chromaticity diagram.

FIG. 3 is a block diagram illustrating a first configuration example of a shadow estimation unit of FIG. 1.

FIG. 4 is a block diagram illustrating an example of a configuration of the shadow estimation unit according to the first configuration example in a case where N=2.

FIG. 5 is a diagram for explaining a configuration of a convolutional neural network (CNN) predictor,

FIG. 6 is a diagram for explaining a setting example in a case where N=3.

FIG. 7 is a diagram for explaining another designation example of a base color in the shadow estimation unit according to the first configuration example.

FIG. 8 is a diagram for explaining another designation example of the base color in the shadow estimation unit according to the first configuration example.

FIG. 9 is a diagram for explaining a method of setting a color space represented by N base colors.

FIG. 10 is a diagram for explaining a basis function of a commission on illumination (CIE) daylight model.

FIG. 11 is a block diagram illustrating a second configuration example of the shadow estimation unit of FIG. 1.

FIG. 12 is a block diagram illustrating a third configuration example of the shadow estimation unit of FIG. 1.

FIG. 13 is a diagram for explaining models for direct light and global light.

FIG. 14 is a diagram for explaining an example of a configuration of training data.

FIG. 15 is a flowchart for explaining object color-shadow separation processing performed by the image processing apparatus of the first embodiment.

FIG. 16 is a block diagram illustrating an example of a configuration of a second embodiment of an image processing apparatus of the present disclosure.

FIG. 17 is a flowchart for explaining object color-shadow separation processing performed by the image processing apparatus of the second embodiment.

FIG. 18 is a diagram for explaining an example of an end condition.

FIG. 19 is a block diagram illustrating an example of a configuration of a third embodiment of an image processing apparatus of the present disclosure.

FIG. 20 is a flowchart for explaining object color-shadow separation processing performed by the image processing apparatus of the third embodiment.

FIG. 21 is a block diagram illustrating an example of a configuration of the image processing apparatus according to the third embodiment that has a cascade structure.

FIG. 22 is a block diagram illustrating an example of a configuration of a learning apparatus that learns a parameter of the CNN predictor.

FIG. 23 is a block diagram illustrating an example of a configuration of a fourth embodiment of an image processing apparatus of the present disclosure.

FIG. 24 is a block diagram illustrating a detailed configuration example of a shadow estimation unit of FIG. 23.

FIG. 25 is a diagram for explaining processing performed by the shadow estimation unit of FIG. 23.

FIG. 26 is a block diagram illustrating an example of a configuration of an embodiment of a computer to which the technology of the present disclosure is applied.

### DESCRIPTION OF EMBODIMENTS

Hereinafter, modes for implementing the present technology (hereinafter, referred to as embodiments) will be described with reference to the accompanying drawings. Note that in the present specification and the drawings, constituent elements having sub-stantially the same functional configuration are denoted by the same reference signs, and an overlapping description is omitted. Descriptions will be provided in the following order.
1. First Embodiment of Image Processing Apparatus
2. First Configuration Example of Shadow Estimation Unit
3. Second Configuration Example of Shadow Estimation Unit
4. Third Configuration Example of Shadow Estimation Unit
5. Example of Configuration of Training Data
6. Object Color-Shadow Separation Processing of First Embodiment
7. Second Embodiment of Image Processing Apparatus
8. Object Color-Shadow Separation Processing of Second Embodiment
9. Third Embodiment of Image Processing Apparatus
10. Object Color-Shadow Separation Processing of Third Embodiment
11. Example of Configuration of Learning Apparatus
12. Fourth Embodiment of Image Processing Apparatus
13. Example of Configuration of Computer

### <1. First Embodiment of Image Processing Apparatus>

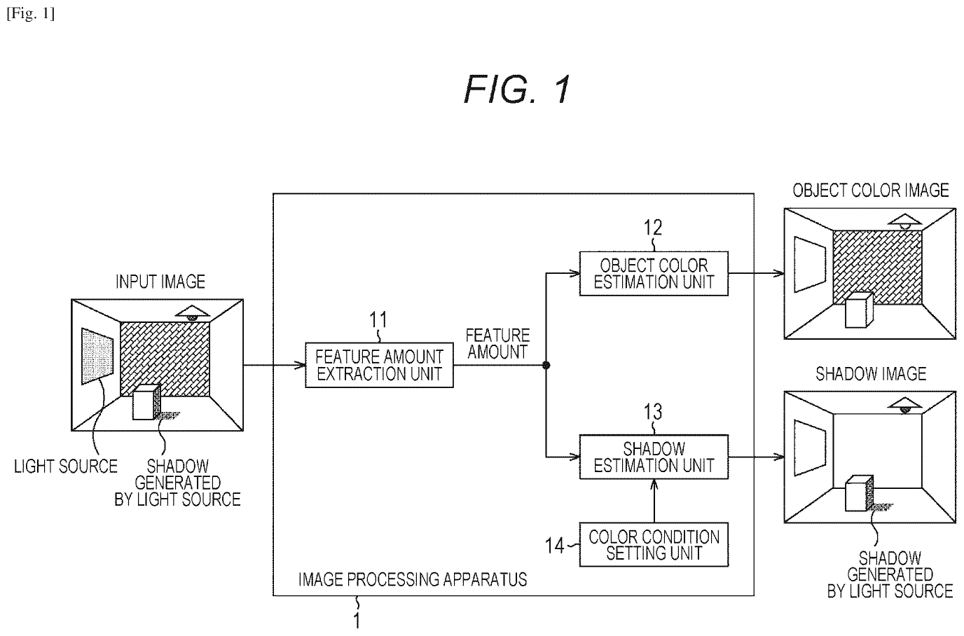

FIG. 1 is a block diagram illustrating an example of a configuration of a first embodiment of an image processing apparatus of the present disclosure.

An image processing apparatus 1 of FIG. 1 is an apparatus that separates an input image that is a color image into an object color image and a shadow image and outputs the images. The object color image is an image having a color component (reflectance component) of an object as a pixel value, and the shadow image is an image having a shadow component by a light source (illumination) or the like as a pixel value.

The image processing apparatus 1 includes a feature amount extraction unit 11, an object color estimation unit 12, a shadow estimation unit 13, and a color condition setting unit 14.

The feature amount extraction unit 11 extracts a feature amount of the input image and supplies the feature amount to the object color estimation unit 12 and the shadow estimation unit 13. The object color estimation unit 12 estimates and outputs the object color image having the color component (reflectance component) of the object included in the input image as the pixel value on the basis of the feature amount of the input image supplied from the feature amount extraction unit 11. The shadow estimation unit 13 estimates and outputs the shadow image having the shadow component of the input image as the pixel value on the basis of the feature amount of the input image supplied from the feature amount extraction unit 11. The color condition setting unit 14 sets a color condition for estimating the shadow image and supplies the color condition to the shadow estimation unit 13. The color condition is set, for example, in accordance with a color condition designated by a user.

The image processing apparatus 1 is characterized in that the shadow estimation unit 13 estimates the shadow image by limiting a color space as a solution space that can be taken by the shadow component to a color space determined under a predetermined color condition from all RGB spaces. For example, since a light source color in nature often follows black-body radiation, a constraint that the estimated shadow color is close to a black-body radiation color is given as the color condition in the color condition setting unit 14.

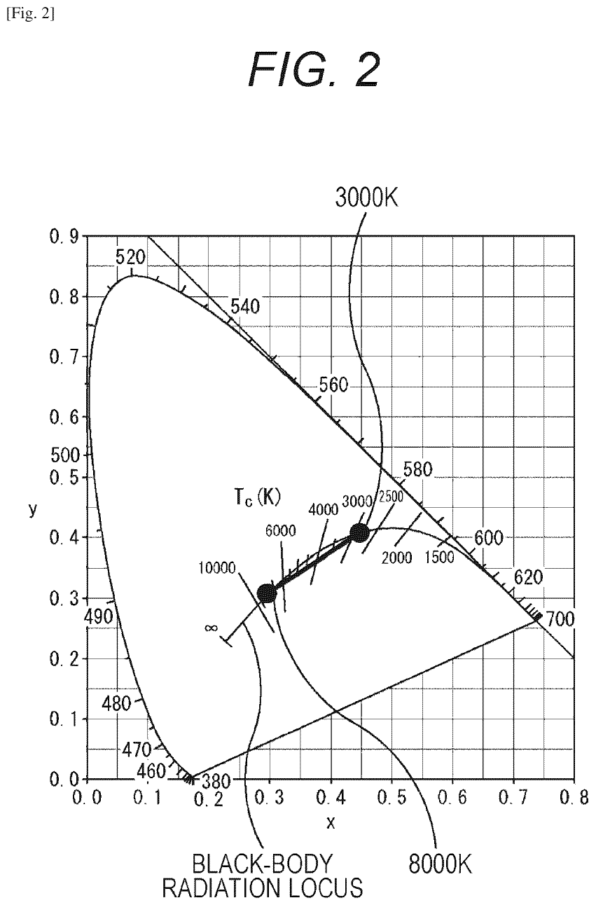

FIG. 2 illustrates an xy chromaticity diagram in which a color of light is represented by plane coordinates of (x,y).

As illustrated in FIG. 2, the black-body radiation color is represented as a curved black-body radiation locus on the xy chromaticity diagram. According to Non Patent Literature “Design of advanced color: Temperature control system for HDTV applications, Journal of the Korean Physical Society”, the black-body radiation locus can be approximated by a cubic spline.

The image processing apparatus 1 assumes that an illumination color of a scene observed in the input image is represented by a linear sum of several colors that serve as a base (hereinafter, also referred to as base colors), and estimates the sum as a final shadow image. Assuming that the number of bases (base number) N of the color space expressed by a plurality of base colors is two and a color temperature T₁=3000 kelvin and a color temperature T₂=8000 kelvin are bases, a color space that can be taken by a shadow image obtained by adding shadow images expressed by the respective base colors is represented by a line segment having two base colors of the color tem-peratures T₁=3000 and T₂=8000 as end points as illustrated in FIG. 2. That is, in a case where the base number N=2, a color appearing in the shadow image always exists in a straight line connecting points representing two base colors on the xy chromaticity diagram. In a case where the base number N>2, the color exists in an N-polygon on the xy chromaticity diagram. As described above, as the color space expressed by the plurality of base colors is set to a space approximating the color space representing the black-body radiation color, it is possible to stably estimate the color of the shadow image and separate the input image into the object color image and the shadow image with a high precision.

### <2. First Configuration Example of Shadow Estimation Unit>

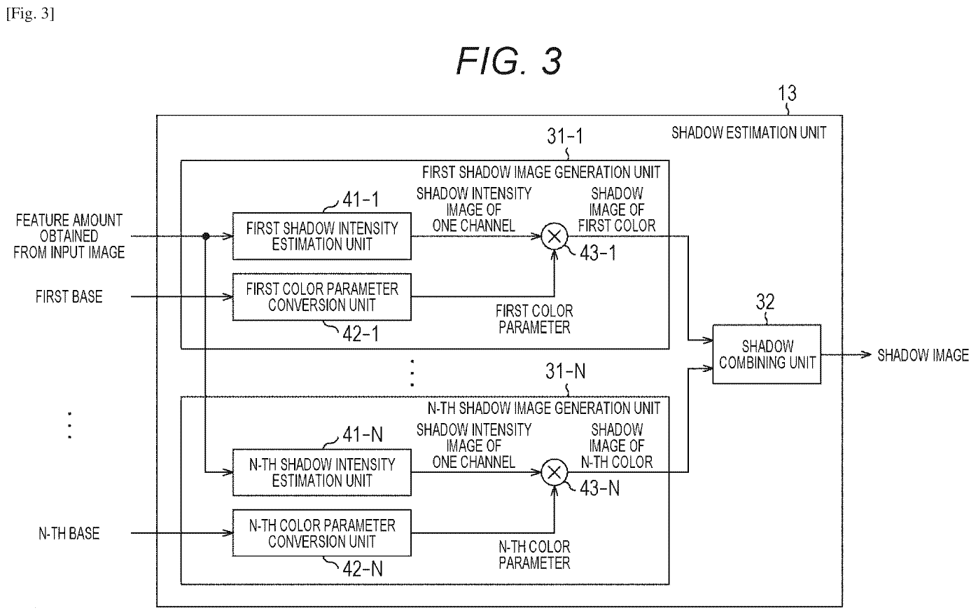

FIG. 3 is a block diagram illustrating a first configuration example of the shadow estimation unit 13.

The shadow estimation unit 13 according to the first configuration example includes first to N-th shadow image generation units 31-1 to 31-N, and a shadow combining unit 32. N corresponding to the number of the shadow image generation units 31 is an integer larger than 1, and corresponds to the number of bases defining the color space of the shadow image.

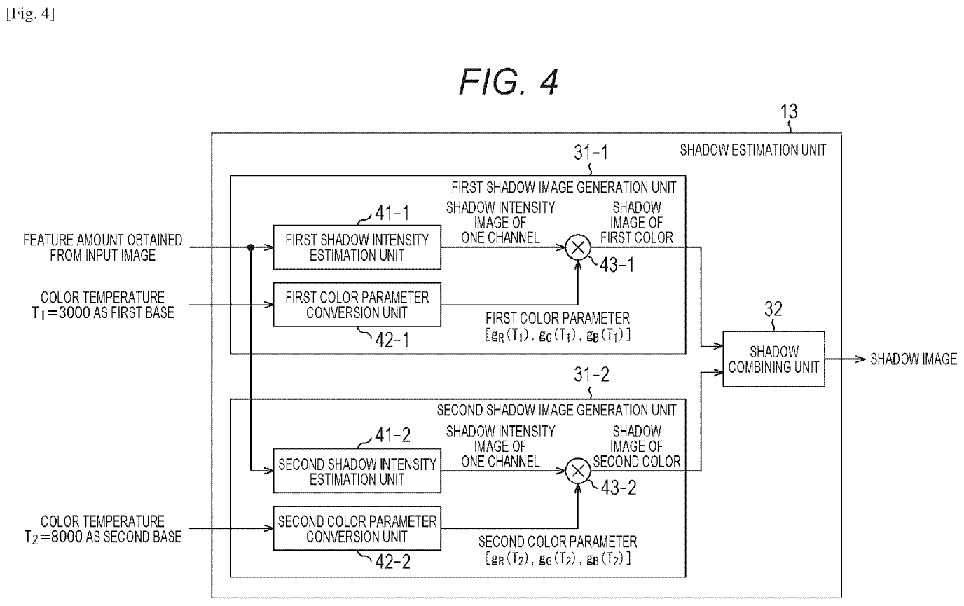

The first to N-th shadow image generation unit 31-1 to 31-N are supplied with different base colors as color conditions from the color condition setting unit 14, but have the same configuration of the shadow image generation unit 31, and perform the same processing by using the supplied base colors. The shadow image generation unit 31 will be described later in detail with reference to FIG. 4. The shadow image generation unit 31 includes a shadow intensity estimation unit 41, a color parameter conversion unit 42, and a multiplication unit 43, and generates a shadow image corresponding to a predetermined base color.

The first shadow image generation unit 31-1 generates a first shadow image corresponding to a color of a first base supplied from the color condition setting unit 14 (a shadow image of a first color). The second shadow image generation unit 31-2 (not illustrated) generates a second shadow image corresponding to a color of a second base supplied from the color condition setting unit 14 (a shadow image of a second color). Similarly, the N-th shadow image generation unit 31-N generates an N-th shadow image corresponding to a color of an N-th base supplied from the color condition setting unit 14 (a shadow image of an N-th color). Each of the shadow images of the first to N-th colors is a shadow image of three channels of R, G, and B.

The shadow combining unit 32 generates (estimates) and outputs a shadow image by combining the shadow images of the first to N-th colors supplied from the first to N-th shadow image generation units 31-1 to 31-N, respectively. Specifically, the com-bination of the shadow images is performed by linearly adding corresponding pixels of the shadow images of the first to N-th colors for each of the R, G, and B channels. The shadow image to be output is expressed by colors of three channels of R, G, and B.

FIG. 4 illustrates an example of a configuration of the shadow estimation unit 13 according to the first configuration example in a case where the base number N is two (N=2), and the color condition setting unit 14 supplies the color temperature T₁=3000 kelvin as the first base and supplies the color temperature T₂=8000 kelvin as the second base as illustrated in FIG. 2 as a base selection method.

The first shadow image generation unit 31-1 includes a first shadow intensity estimation unit 41-1, a first color parameter conversion unit 42-1, and a multiplication unit 43-1. The feature amount of the input image extracted by the feature amount extraction unit 11 is supplied to the first shadow intensity estimation unit 41-1. The color condition setting unit 14 supplies the color temperature T₁=3000 kelvin as the first base to the first color parameter conversion unit 42-1 as the color condition.

The first shadow intensity estimation unit 41-1 estimates an intensity image (hereinafter, referred to as a shadow intensity image) of a shadow component of one channel corresponding to the base color supplied from the color condition setting unit 14 on the basis of the feature amount of the input image extracted by the feature amount extraction unit 11. The estimated shadow intensity image is supplied to the multiplication unit 43-1.

The first color parameter conversion unit 42-1 converts the color temperature T₁=3000 supplied from the color condition setting unit 14 into a first color parameter. The first color parameter is expressed by a color parameter [g_{R}(T₁), g_{G}(T₁), g_{B}(T₁)] of three channels of red (R), green (G), and blue (B). The color parameter [g_{R}(T₁), g_{G}(T₁), g_{B}(T₁))] of three channels generated by the conversion is supplied to the multiplication unit 43-1.

The multiplication unit 43-1 generates the shadow image of the first color in which the color is expressed by the first color parameter by multiplying the shadow intensity image of one channel estimated by the first shadow intensity estimation unit 41-1 by the color parameter [g_{R}(T₁), g_{G}(T₁), g_{B}(T₁)] of each of the R, G, and B channels. The multiplication unit 43-1 supplies the generated shadow image of the first color to the shadow combining unit 32. The shadow image of the first color is a shadow image of three channels of R, G, and B.

The second shadow image generation unit 31-2 includes a second shadow intensity estimation unit 41-2, a second color parameter conversion unit 42-2, and a multiplication unit 43-2. The feature amount of the input image extracted by the feature amount extraction unit 11 is supplied to the second shadow intensity estimation unit 41-2. The color condition setting unit 14 supplies the color temperature T₂=8000 kelvin as the second base to the second color parameter conversion unit 42-2 as the color condition.

The second shadow intensity estimation unit 41-2 estimates a shadow intensity image of one channel corresponding to the base color supplied from the color condition setting unit 14 on the basis of the feature amount of the input image extracted by the feature amount extraction unit 11. The estimated shadow intensity image is supplied to the multiplication unit 43-2.

The second color parameter conversion unit 42-2 converts the color temperature T₂=8000 supplied from the color condition setting unit 14 into a second color parameter. The second color parameter is expressed by a color parameter [g_{R}(T₂), g_{G}(T₂), g_{B}(T₂)] of three channels of R, G, and B. The color parameter [g_{R}(T₂), g_{G}(T₂), g_{B}(T₂)] of three channels generated by the conversion is supplied to the multiplication unit 43-2. The multiplication unit 43-2 generates the shadow image of the second color in which the color is expressed by the second color parameter by multiplying the shadow intensity image of one channel estimated by the second shadow intensity estimation unit 41-2 by the color parameter [g_{R}(T₂), g_{G}(T₂), g_{B}(T₂)] of each of the R, G, and B channels. The multiplication unit 43-2 supplies the generated shadow image of the second color to the shadow combining unit 32. The shadow image of the second color is a shadow image of three channels of R, G, and B.

The shadow combining unit 32 generates (estimates) and outputs a shadow image by combining the shadow image of the first color supplied from the first shadow image generation unit 31-1 and the shadow image of the second color supplied from the second shadow image generation unit 31-2.

Conversion from a color temperature Ta into a color parameter [g_{R}(Tₙ), g_{G}(Tₙ), g_{B}(Tₙ)] performed by the n-th color parameter conversion unit 42-n (n=1 or 2) will be described. The color parameter [g_{R}(Tₙ), g_{G}(Tₙ), g_{B}(Tₙ)] is a so-called RGB value, and represents a ratio of color intensities of R, G, and B. The conversion from the color temperature Tₙ into the color parameter [g_{R}(Tₙ), g_{G}(Tₙ), g_{B}(Tₙ)] can be made using, for example, the Planck's equation or Wein model. Hereinafter, conversion using the Wein model will be described.

The Wein model shows a relationship of energy I(λ, Tₙ) emitted from a black body at a wavelength λ in a case where the color temperature is Th, and can be expressed by the following Equation (1).

$$\begin{matrix}[ Math . 1 ] & \\ I ( λ , {T}_{n} ) = \frac{2 {hc}^{2}}{{λ}^{5}} {e}^{- \frac{ch}{λ {kT}_{n}}} & ( 1 )\end{matrix}$$

In Equation (1), h represents a Planck's constant, and for example, h=6.626×10⁻³⁴. k is a Boltzmann constant, and for example, k=1.3806×10⁻²³. c is a constant representing the speed of light, and for example, c=2.9979×10⁸.

In a case of using a camera including RGB pixels to acquire the input image, sensor spectral sensitivity of each of R, G, and B is set in such a way that each color ap-proximately has narrowband wavelength sensitivity only for wavelengths λ_{R}, λ_{G}, and λ_{B}, and energies at the wavelengths λ_{R}, λ_{G}, and λ_{B} in a case where the color temperature is Tₙ are obtained as I(λ_{R}, Tₙ), I(A_{G}, Tₙ), and I(λ_{B}, Tₙ). Here, in a case where g_{G}(Tₙ) in the color parameter g(Tₙ)=[g_{R}(Tₙ), g_{G}(Tₙ), g_{B}(Tₙ)] is 1, that is, in a case where the shadow intensity image of one channel obtained from the shadow intensity estimation unit 41 corresponds to the channel G among three channels of R, G, and B, g_{R}(Tₙ) and g_{B}(Tₙ) are obtained by the following Equation.

$$\begin{matrix}[ Math . 2 ] & \\ {g}_{R} = \frac{I ( {λ}_{R} , {T}_{n} )}{I ( {λ}_{G} , {T}_{n} )} , {g}_{B} = \frac{I ( {λ}_{B} , {T}_{n} )}{I ( {λ}_{G} , {T}_{n} )} & \end{matrix}$$

In a case where either λ_{R} or λ_{B} is λ_{C}, the color parameter g_{C}(Tₙ)={g_{R}(Tₙ) or g_{B}(Tₙ) corresponding to λ_{C}} can be solved as Equation (2).

$$\begin{matrix}[ Math . 3 ] & \\ {g}_{c} ( {T}_{n} ) = \frac{I ( {λ}_{c} , {T}_{n} )}{I ( {λ}_{G} , {T}_{n} )} = {k}_{1} ( {λ}_{c} ) \cdot exp ( - \frac{{k}_{2} ( {λ}_{c} )}{{T}_{n}} ) \\ {k}_{1} ( {λ}_{c} ) = {( \frac{{λ}_{G}}{{λ}_{c}} )}^{5} , {k}_{2} ( {λ}_{c} ) = \frac{hc ( {λ}_{G} - {λ}_{c} )}{k {λ}_{c} {λ}_{G}} & ( 2 )\end{matrix}$$

It is possible to generate the shadow image of the n-th color in a case where the color temperature is Tₙ, by multiplying the color parameter g(Tₙ)=[g_{R}(Tₙ), g_{G}(Tₙ), g_{B}(Tₙ)] by the shadow intensity image of one channel obtained from the shadow intensity estimation unit 41.

### <Example of Configuration of Convolutional Neural Network (CNN) Predictor>

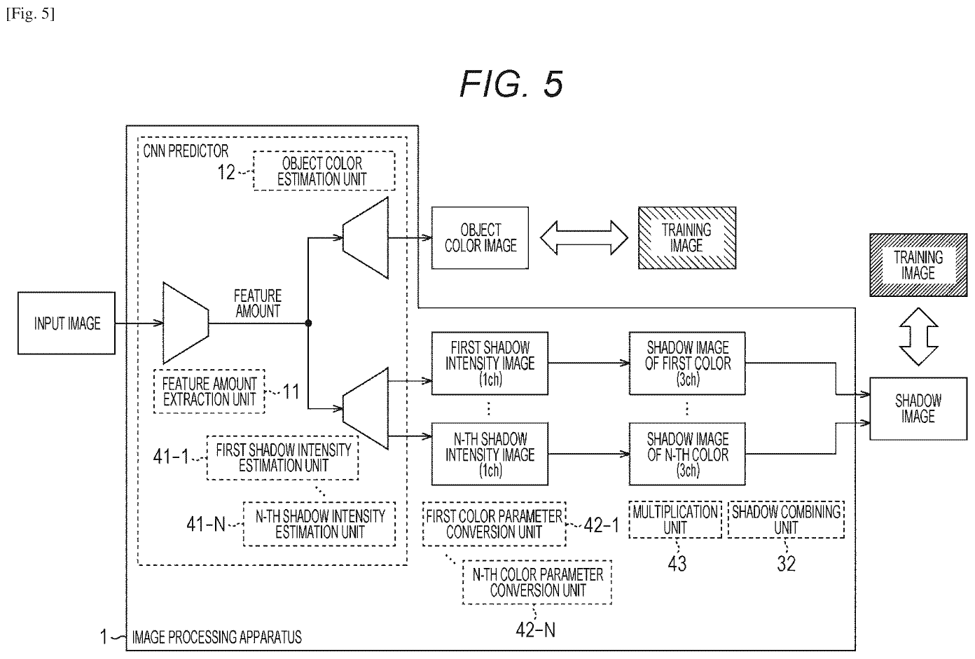

As illustrated in FIG. 5, the image processing apparatus 1 can implement the feature amount extraction unit 11, the object color estimation unit 12, and the first to N-th shadow intensity estimation units 41-1 to 41-N of the shadow estimation unit 13 by a CNN predictor using a CNN. Once a predetermined input image is input, the CNN predictor is trained to output one object color image and shadow intensity images of N channels according to the base number N. The (N) shadow intensity images of N channels estimated by the CNN predictor are supplied channel by channel to the first to N-th shadow intensity estimation units 41-1 to 41-N.

In learning processing for the CNN predictor, a parameter of the CNN predictor is optimized in such a way that the object color image obtained from the object color estimation unit 12 and the shadow image obtained from the shadow estimation unit 13 approach an object color image and a shadow image serving as trainers, respectively. Since all the computations of the first to N-th color parameter conversion units 42-1 to 42-N, the multiplication units 43-1 to 43-N, and the shadow combining unit 32 downstream of the CNN predictor are also differentiable, the parameter can be optimized by error back propagation. With the learning processing, for example, the shadow intensity image of one channel output from the first shadow intensity estimation unit 41-1 is learned to correspond to the first base color, and the shadow intensity image of one channel output from the N-th shadow intensity estimation unit 41-N is learned to correspond to the N-th base color.

In a case where the base number N is two (N=2), the color temperature T₁=3000 kelvin is set as the first base, and the color temperature T₂=8000 kelvin is set as the second base, the color space that can be taken by the shadow image is a color in a straight line connecting a point of the color temperature T₁=3000 kelvin as the first base and a point of the color temperature T₂=8000 kelvin as the second base as illustrated in FIG. 2, and the shadow image approximates a curved black-body radiation locus.

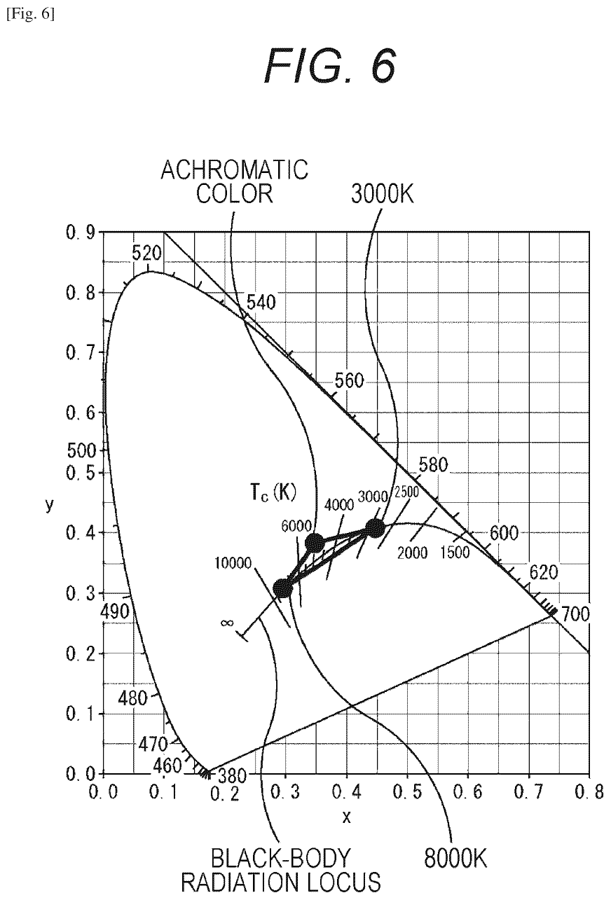

For example, in a case where the base number N is three (N=3), an achromatic color represented by (x,y)=(0.33,0.33) is set as a third base, in addition to the color temperature T₁=3000 kelvin as the first base and the color temperature T₂=8000 kelvin as the second base, the color space that can be taken by the shadow image is a color inside a triangle having each of the first to third bases as a vertex as illustrated in FIG. 6, and the shadow image approximates a curved black-body radiation locus.

### <Another Designation Example of Base Color>

In the above-described example, the color temperature Ta (n=1, 2, . . . , N) is designated as the color condition in the color condition setting unit 14 and supplied to the n-th color parameter conversion unit 42-n of the first shadow image generation unit 31-n.

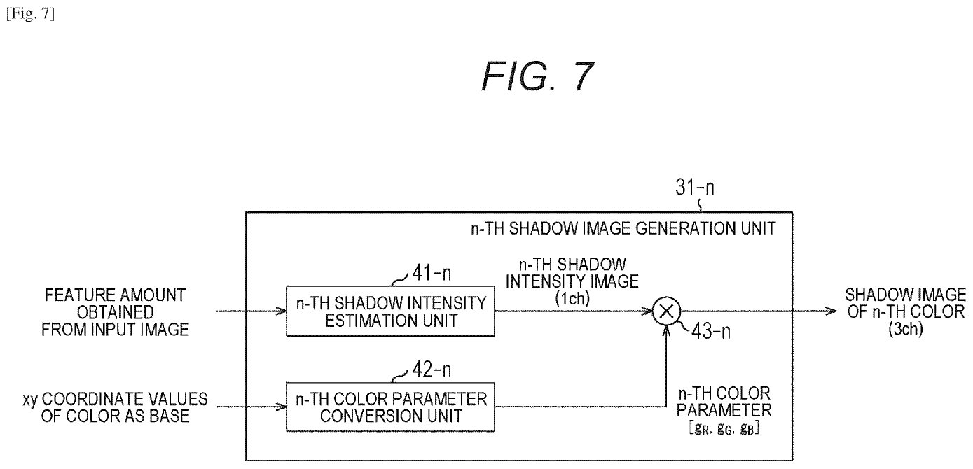

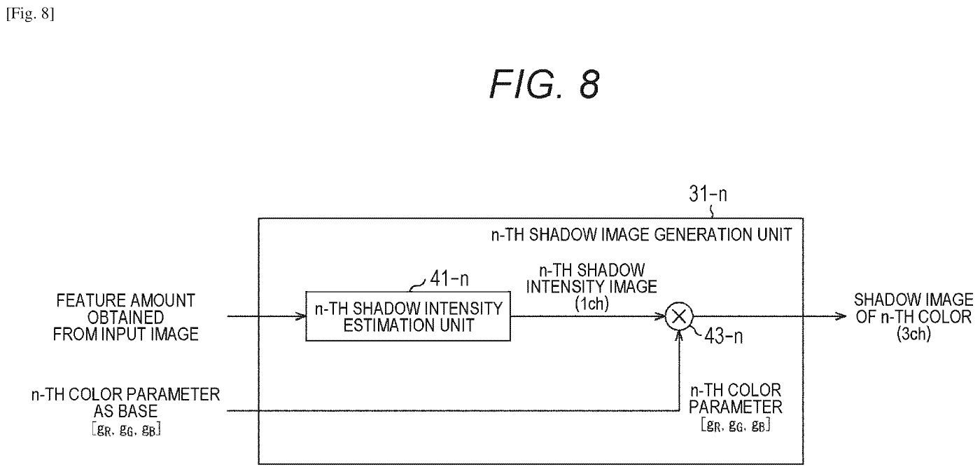

However, a method of designating the color condition is not limited to this example, and other designation methods may be adopted. For example, as illustrated in FIG. 7, the base color may be designated with xy coordinate values on the xy chromaticity diagram. Alternatively, as illustrated in FIG. 8, the color parameter [g_{R}(Tₙ), g_{G}(Tₙ), g_{B}(T n)] of three channels of R, G, and B described above may be directly designated as the base color. In a case where the color parameter [g_{R}(Tₙ), g_{G}(Tₙ), g_{B}(Tₙ)] is directly designated as the base color, the n-th color parameter conversion unit 42-n is omitted.

With the shadow estimation unit 13 according to the first configuration example described above, it is possible to stably estimate the shadow image by limiting the color space that can be taken by the shadow image to a color space represented by N base colors, which enables separation of the input image into the object color image and the shadow image with a high precision.

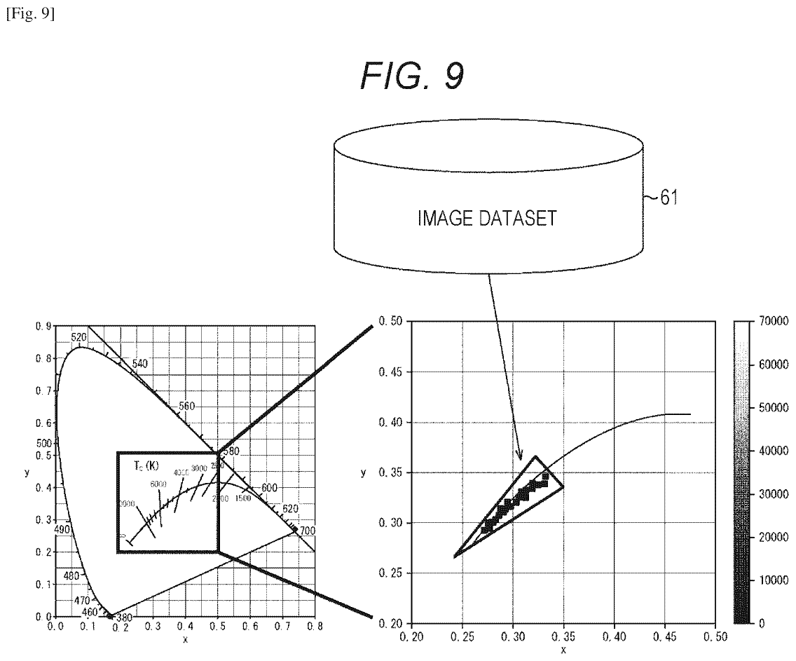

In the example described above, the shadow image is estimated by placing a constrain that the solution space (color space) that can be taken by the shadow component is limited to the color space expressed by N base colors from all the RGB spaces, but this solution space may be set from xy chromaticity distribution of the actual image. Specifically, as illustrated in FIG. 9, distribution of the light source color on the xy chromaticity diagram may be obtained from an image dataset 61 such as a shadow dataset or a light source color dataset, and N bases may be set in such a way that a convex hull surrounding the distribution becomes the solution space.

### <3. Second Configuration Example of Shadow Estimation Unit>

Next, a second configuration example of the shadow estimation unit 13 will be described.

In the first configuration example described above, a constrain that the solution space that can be taken by the shadow component is limited to the color space represented by N base colors on the xy chromaticity diagram is placed, but in the second configuration example, a constraint that the shadow image is based on a commission on illumination (CIE) daylight model.

According to Non Patent Literature “Deane B. Judd, David L. Macadam, and Gunter Wyszecki. Spectral distribution of typical daylight as a function of correlated color temperature. J. Opt. Soc. Am, 54(8): 1031-1040, 1964”, the CIE daylight model can be expressed as the following Equation (3) as spectral distribution I_{CIE}(λ) of a wavelength λ.

$${I}_{CIE} ( λ ) = {M}_{1} {I}_{1} ( λ ) + {M}_{2} {I}_{2} ( λ ) + {M}_{3} {I}_{3} ( λ ) \qquad ( 3 )$$

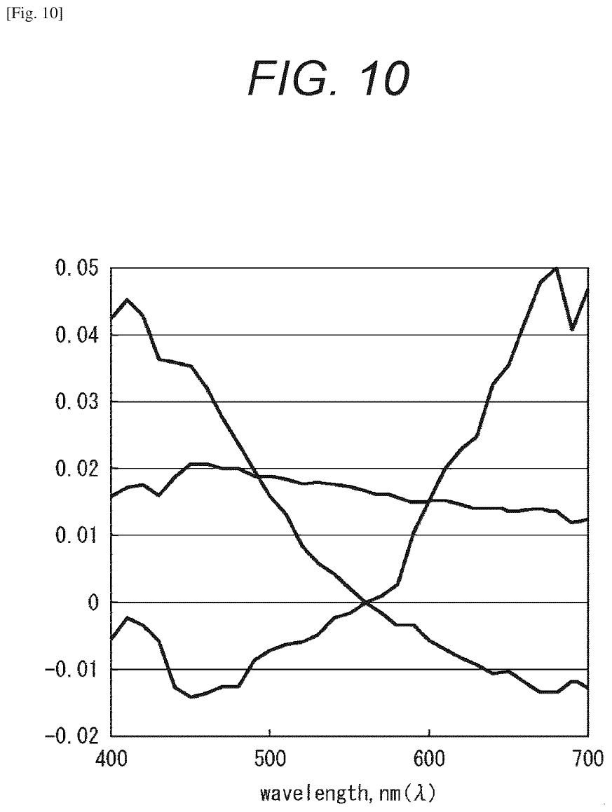

In Equation (3), I₁(λ), I₂(λ), and I₃(λ) are basis functions for expressing a daylight color based on actual measurement, and are expressed as in FIGS. 10. M₁, M₂, and M₃ represent coefficients (parameters) for designating the light source color.

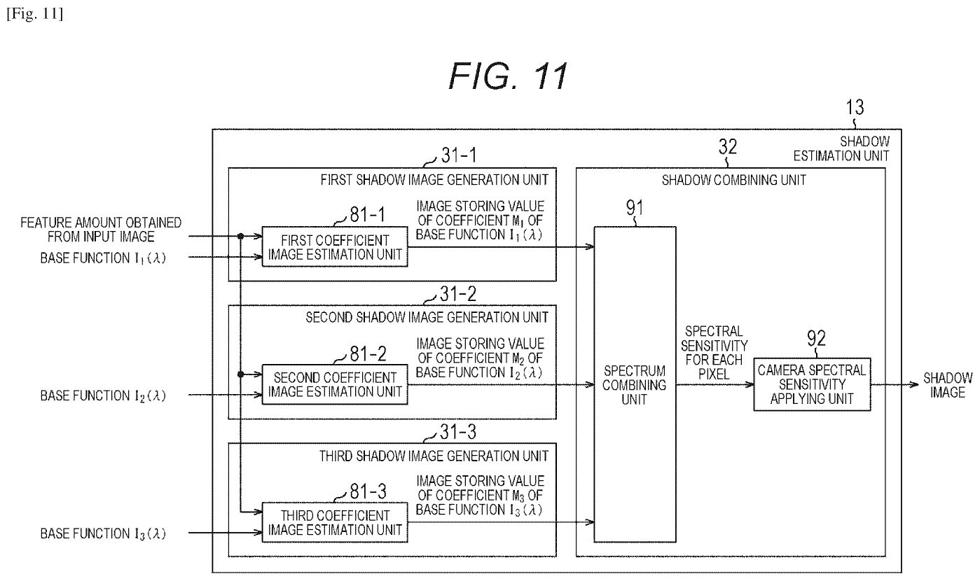

FIG. 11 is a block diagram illustrating the second configuration example of the shadow estimation unit 13.

The shadow estimation unit 13 according to the second configuration example includes first to third shadow image generation units 31-1 to 31-3, and a shadow combining unit 32. Each of the first to third shadow image generation unit 31-1 to 31-3 has the same configuration including a coefficient image estimation unit 81, and the basis functions supplied as the color conditions from the color condition setting unit 14 are different, but the same processing is performed using the supplied basis functions. The first to third shadow image generation unit 31-1 to 31-3 correspond to the basis functions I₁(λ), I₂(λ), and I₃(λ), respectively. The shadow combining unit 32 includes a spectrum combining unit 91 and a camera spectral sensitivity applying unit 92.

The first shadow image generation unit 31-1 includes a first coefficient image estimation unit 81-1. The feature amount of the input image extracted by the feature amount extraction unit 11 and the basis function I₁(λ) as the color condition are supplied from the color condition setting unit 14 to the first coefficient image estimation unit 81-1.

The first shadow image generation unit 31-1 estimates a first coefficient image in which the coefficient M₁ of the basis function I₁(λ) is stored for each pixel from the feature amount of the input image and the basis function I₁(λ), and supplies the first coefficient image to the spectrum combining unit 91.

The second shadow image generation unit 31-2 includes a second coefficient image estimation unit 81-2. The feature amount of the input image extracted by the feature amount extraction unit 11 and the basis function I₂(λ) as the color condition are supplied from the color condition setting unit 14 to the second coefficient image estimation unit 81-2.

The second shadow image generation unit 31-2 estimates a second coefficient image in which the coefficient M₂ of the basis function I₂(λ) is stored for each pixel from the feature amount of the input image and the basis function I₂(λ), and supplies the second coefficient image to the spectrum combining unit 91.

The third shadow image generation unit 31-3 includes a third coefficient image estimation unit 81-3. The feature amount of the input image extracted by the feature amount extraction unit 11 and the basis function I₃(λ) as the color condition are supplied from the color condition setting unit 14 to the third coefficient image estimation unit 81-3.

The third shadow image generation unit 31-3 estimates a third coefficient image in which the coefficient M₃ of the basis function I₃(λ) is stored for each pixel from the feature amount of the input image and the basis function I₃(λ), and supplies the third coefficient image to the spectrum combining unit 91.

The spectrum combining unit 91 calculates spectral distribution I_{CIE}(λ) of the wavelength λ in the CIE daylight model for each pixel by performing computation of Equation (3) for each pixel of the first to third coefficient images. The spectrum combining unit 91 supplies, as the calculation result, a shadow spectral distribution image obtained by combining the first to third coefficient images to the camera spectral sensitivity applying unit 92.

The camera spectral sensitivity applying unit 92 convolves the shadow spectral distribution image with each of spectral sensitivity functions of R, G, and B of the camera that has captured the input image, thereby converting the shadow spectral distribution image into the shadow image of three channels of R, G, and B.

The camera spectral sensitivity applying unit 92 outputs the shadow image of three channels of R, G, and B generated by the conversion as the shadow image estimated by the shadow combining unit 32.

With the shadow estimation unit 13 according to the second configuration example described above, it is possible to stably estimate the shadow image by placing a constraint that the shadow image is based on the CIE daylight model, which enables separation of the input image into the object color image and the shadow image with a high precision.

### <4. Third Configuration Example of Shadow Estimation Unit>

Next, a third configuration example of the shadow estimation unit 13 will be described.

In the first configuration example described above, a constraint that the solution space that can be taken by the shadow component is limited to the color space represented by N base colors on the xy chromaticity diagram is placed. In the third configuration example, a case where the input image is an image captured outdoors is assumed, a configuration in which the shadow component is estimated by setting a model based on a time (imaging time) at which the input image is captured is adopted.

The light source color in the outdoors is mainly divided into two types of light: direct light that is directly illuminated from a sunlight source to an object, and global light that is illuminated to the object after multiple reflection in a cloud or a surrounding en-vironment. The direct light is mainly observed in a sunny place, and the global light is mainly observed in a shady place.

In the third configuration example, the number of shadow image generation units 31, which is N in the first configuration example, is limited to two corresponding to the direct light and the global light. The shadow image of the first color using the color parameter g(T₁)=[g_{R}(T₁), g_{G}(T₁), g_{B}(T₁)] corresponding to the direct light and the shadow image of the second color using the color parameter g(T₂)=[g_{R}(T₂), g_{G}(T₂), g_{B} (T₂)] corresponding to the global light are generated and combined to generate the shadow image of three channels of R, G, and B.

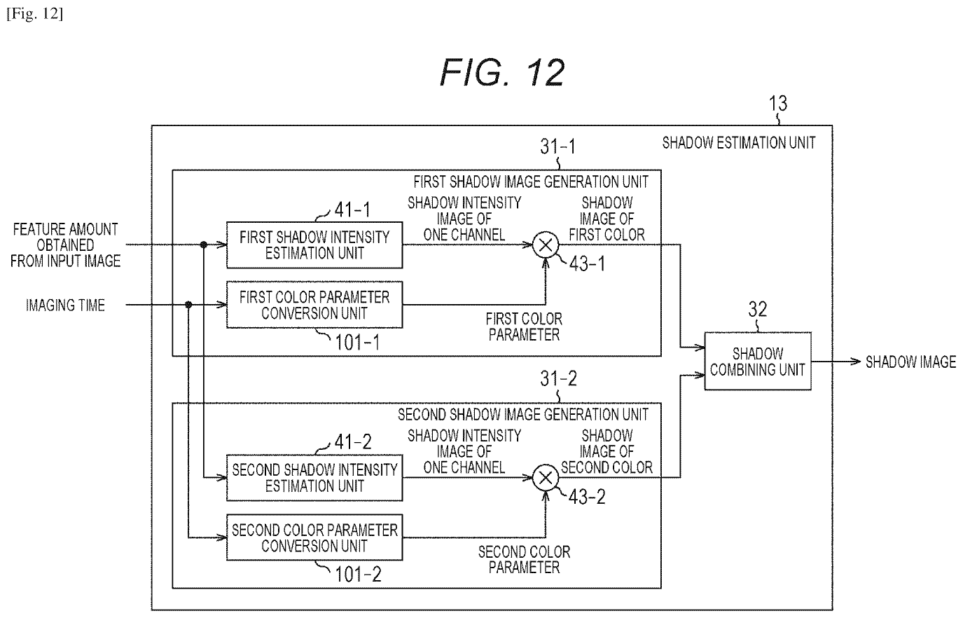

FIG. 12 is a block diagram illustrating the third configuration example of the shadow estimation unit 13.

The shadow estimation unit 13 according to the third configuration example includes a first shadow image generation unit 31-1 and a second shadow image generation unit 31-2, and a shadow combining unit 32. The first shadow image generation unit 31-1 includes a first shadow intensity estimation unit 41-1, a first color parameter conversion unit 101-1, and a multiplication unit 43-1. The second shadow image generation unit 31-2 includes a second shadow intensity estimation unit 41-2, a second color parameter conversion unit 101-2, and a multiplication unit 43-2.

The shadow estimation unit 13 according to the third configuration example is different from the first configuration example illustrated in FIG. 3 in that the number of shadow image generation units 31 is limited to two and the color parameter conversion unit 42 is replaced with the color parameter conversion unit 101, and the other configurations are common.

The first shadow image generation unit 31-1 generates the shadow image of the first color corresponding to the direct light, and supplies the shadow image to the shadow combining unit 32. The second shadow image generation unit 31-2 generates the shadow image of the second color corresponding to the global light, and supplies the shadow image to the shadow combining unit 32.

The imaging time is supplied from the color condition setting unit 14 to the first color parameter conversion unit 101-1 and the second color parameter conversion unit 101-2 as the color condition.

The first color parameter conversion unit 101-1 converts the supplied imaging time into the color parameter g(T₁)=[g_{R}(T₁), g_{G}(T₁), g_{B}(T₁)] corresponding to the direct light. The second color parameter conversion unit 101-2 converts the supplied imaging time into the color parameter g(T₂)=[g_{R}(T₂), g_{G}(T₂), g_{B}(T₂)] corresponding to the global light.

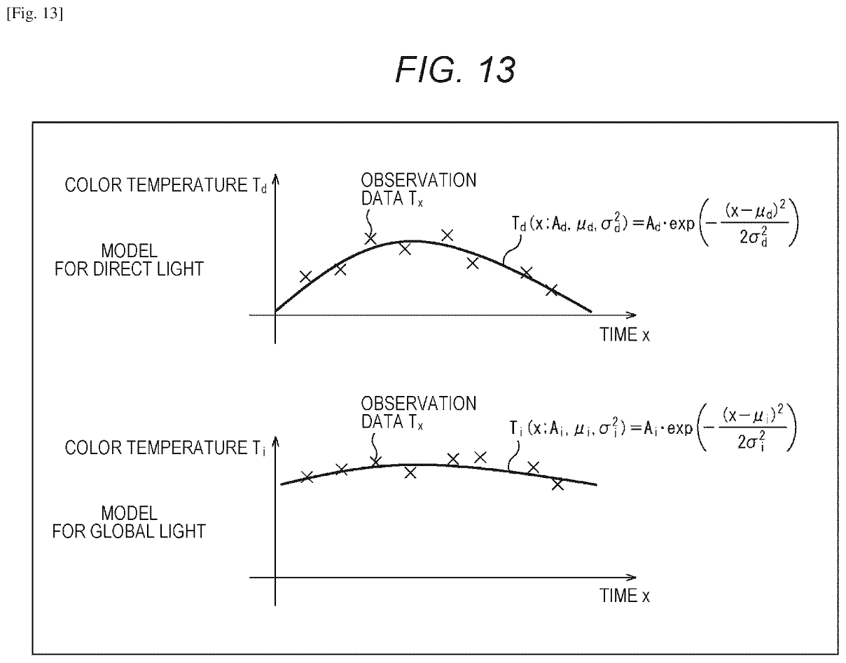

For example, as disclosed in “Seo et al., Real-time adaptable and coherent rendering for outdoor augmented reality, EURASIP Journal on Image and Video Processing, 2018”, it is known that spectral distribution of the direct light of sunlight changes with time, but a locus thereof can be approximated by a monomodal function. Therefore, learning data obtained by measuring the light source colors of the direct light and the global light for each time in advance in a scene assumed for the use is created, and as illustrated in FIG. 13, a normal distribution or a function of second or higher order de-scribing a relationship between the imaging time and the color temperature is generated for each of the direct light and the global light on the basis of the learning data, and the generated function is stored in the first color parameter conversion unit 101-1 and the second color parameter conversion unit 101-2. The relationship between the imaging time and the color temperature described by the normal distribution or the function of second or higher order is a differentiable function, and thus can be learned by being incorporated in the CNN.

For example, a range from 9:00 AM to 5:00 PM is equally divided into M parts, and a color temperature Ta of the direct light at time x∈[0,M] is modeled by a normal distribution T_{d}(x; A_{d}, μ_{d}, o_{d}²) of Equation (4).

$$\begin{matrix}[ Math . 4 ] & \\ {T}_{d} ( x ; {A}_{d} , {μ}_{d} , {σ}_{d}^{2} ) = {A}_{d} \cdot exp ( - \frac{{( x - {μ}_{d} )}^{2}}{2 {σ}_{d}^{2}} ) & ( 4 )\end{matrix}$$

In a case where a sequence of the light source color measured at time x is {Tₓ}, the parameters A_{d}, μ_{d}, and o_{d}² at T_{d}(x; A_{d}, μ_{d}, o_{d}²) can be obtained as A_{d}_ min, μ_{d}_min, and o_{d}²_min that minimizes a square error J between {Tₓ} and T_{d}(x; A_{d}, μ_{d}, o_{d}²) expressed by Equation (5) on a logarithmic space.

$$\begin{matrix}[ Math . 5 ] & \\ J = {\sum }_{x} {\{ ln {T}_{x} - ( ln A - \frac{{μ}_{d}^{2}}{2 {σ}_{d}^{2}} + \frac{{μ}_{d}}{{σ}_{c}^{2}} x - \frac{1}{2 {σ}_{d}^{2}} {x}^{2} ) \}}^{2} & ( 5 )\end{matrix}$$

As described above, once the imaging time is supplied, the color temperature T_{d} of the direct light can be determined, so that the color parameter g(T₁)=[g_{R}(T₁), g_{G}(T₁), g_{B}(T₁)] corresponding to the color temperature T_{d} can be generated similarly to the first configuration example. Similarly for the global light, a color temperature T₁ of the global light is modeled by a normal distribution T₁(x; Aᵢ, μᵢ, oᵢ²), and the color parameter g(T₂)=[g_{R}(T₂), g_{G}(T₂), g_{B}(T₂)] corresponding to the color temperature Tᵢ of the global light at the imaging time can be generated.

With the shadow estimation unit 13 according to the third configuration example described above, it is possible to stably estimate the shadow image by placing a constraint that the shadow image is based on the model for the direct light and the model for the global light, which enables separation of the input image into the object color image and the shadow image with a high precision.

### <5. Example of Configuration of Training Data>

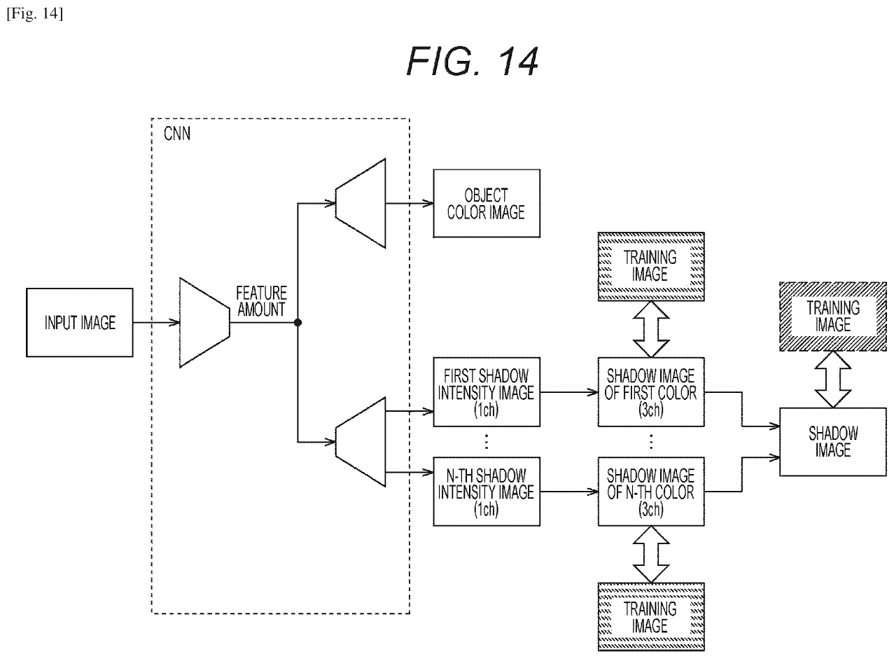

In the first to third configuration examples described above, in the learning processing for the CNN predictor, the parameter of the CNN predictor that minimizes the loss function is learned by comparing the shadow image finally output by the shadow estimation unit 13 with a training image. However, as illustrated in FIG. 14, the parameter of the CNN predictor that minimizes the loss function may also be learned by comparing the shadow images of the first to N-th colors before being combined by the shadow combining unit 32 with the training image. The training image for the shadow images of the first to N-th colors can be generated with, for example, computer graphics (CG) or the like.

### <6. Object Color-Shadow Separation Processing of First Embodiment>

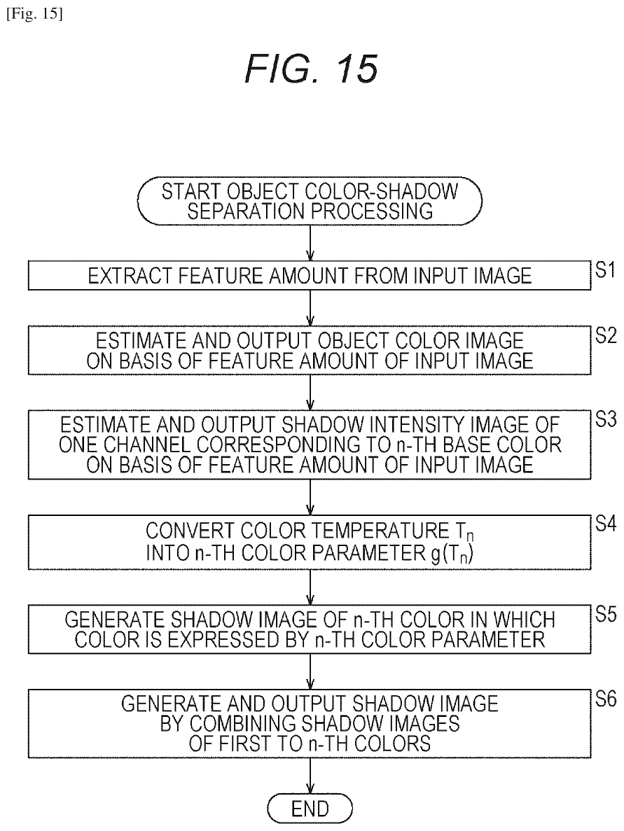

Next, object color-shadow separation processing performed by the image processing apparatus 1 according to the first embodiment will be described with reference to a flowchart of FIG. 15. In FIG. 15, the object color-shadow separation processing in a case where the shadow estimation unit 13 corresponds to the first configuration example illustrated in FIG. 3 will be described. The object color-shadow separation processing is started, for example, once the input image is supplied to the image processing apparatus 1.

First, in Step S1, the feature amount extraction unit 11 extracts the feature amount of the input image and supplies the feature amount to the object color estimation unit 12 and the shadow estimation unit 13.

In Step S2, the object color estimation unit 12 estimates and outputs the object color image having the color component (reflectance component) of the object included in the input image as the pixel value on the basis of the feature amount of the input image supplied from the feature amount extraction unit 11.

In Step S3, the n-th shadow intensity estimation unit 41-n (n=1, 2, 3, . . . , N) estimates the shadow intensity image of one channel corresponding to the n-th base color supplied from the color condition setting unit 14 on the basis of the feature amount of the input image extracted by the feature amount extraction unit 11, and outputs the estimation result to the multiplication unit 43-n. The first to N-th shadow intensity estimation units 41-1 to 41-N can simultaneously perform processing of estimating the shadow intensity image of one channel in parallel.

In Step S4, the n-th color parameter conversion unit 42-n converts the color temperature Tₙ supplied from the color condition setting unit 14 into an n-th color parameter. The n-th color parameter is expressed by the color parameter g(Tₙ)=[g_{R}(Tₙ), g_{G}(Tₙ), g_{B}(Tₙ)] of three channels of R, G, and B. The color parameter [g_{R}(Tₙ), g_{G}(Tₙ), g_{B}(Tₙ)] of three channels generated by the conversion are supplied to the multiplication unit 43-n. The first to N-th color parameter conversion units 42-1 to 42-N can simultaneously perform the conversion processing for the color parameter g (TR) in parallel.

In Step S5, the multiplication unit 43-n generates the shadow image of the n-th color in which the color is expressed by the n-th color parameter by multiplying the shadow intensity image of one channel estimated by the n-th shadow intensity estimation unit 41-n by the color parameter [g_{R}(Tₙ), g_{G}(Tₙ), g_{B}(Tₙ)] of each of the R, G, and B channels. The multiplication units 43-1 to 43-N can simultaneously perform processing of generating the shadow images of the first to N-th colors by multiplication in parallel. The generated shadow images of the first to N-th colors are supplied to the shadow combining unit 32.

In Step S6, the shadow combining unit 32 generates and outputs the shadow image by combining the shadow images of the first to N-th colors.

The processing of Step S2 of estimating and outputting the object color image and the processing of Steps S3 to S6 of generating and outputting the shadow image can be simultaneously performed in parallel.

Once the object color image and the shadow image are generated and output from the image processing apparatus 1, the object color-shadow separation processing in FIG. 15 ends.

The object color-shadow separation processing in a case where the shadow estimation unit 13 corresponds to the first configuration example illustrated in FIG. 3 is performed as described above. In a case where the shadow estimation unit 13 corresponds to the second configuration example illustrated in FIG. 11, the processing in Steps S3 to S5 is replaced with the processing in the first to third coefficient image estimation units 81-1 to 81-3, and the processing in Step S6 is replaced with the processing in the spectrum combining unit 91 and the camera spectral sensitivity applying unit 92. In a case where the shadow estimation unit 13 corresponds to the third configuration example illustrated in FIG. 12, the processing in Step S4 is replaced with the processing in the first color parameter conversion unit 101-1 and the second color parameter conversion unit 101-2.

With the image processing apparatus 1 according to the first embodiment, it is possible to stably estimate the shadow image by limiting the solution space that can be taken by the shadow component to a color space of a predetermined model from all the RGB spaces. As a result, separation into the object color image and the shadow image can be implemented with a higher precision, and more properly separated object color image and shadow image can be output.

### <7. Second Embodiment of Image Processing Apparatus>

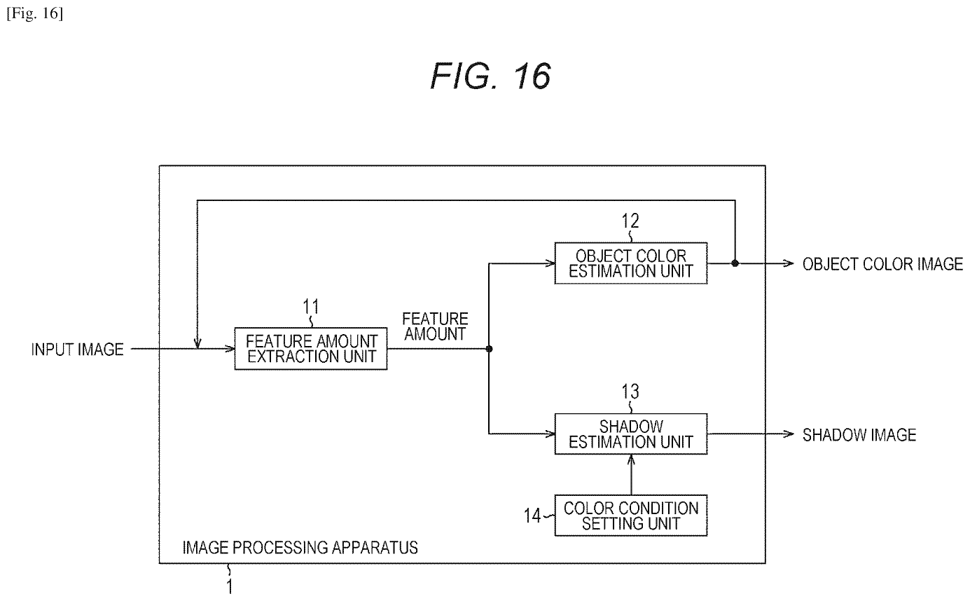

FIG. 16 is a block diagram illustrating an example of a configuration of a second embodiment of an image processing apparatus of the present disclosure.

The second embodiment in FIG. 16 is different from the above-described first embodiment in that the object color image output by the object color estimation unit 12 is input again to the feature amount extraction unit 11, and the other configurations are common.

Also in the first embodiment described above, since there is no change in having an ill-posed problem of obtaining two variables of the object color and the shadow from one input image, separation into the object color and the shadow can be insufficiently made.

In the image processing apparatus 1 according to the second embodiment, it is determined whether or not the object color image output by the object color estimation unit 12 satisfies a predetermined end condition determined in advance. In a case where the predetermined end condition is not satisfied, it is determined that the separation into the object color image and the shadow image is insufficiently made and the shadow remains in the object color image, and the object color image estimated by the object color estimation unit 12 is input again to the feature amount extraction unit 11. Then, the object color image and the shadow image in a case where it is determined that the predetermined end condition is satisfied are output from the image processing apparatus 1 as the final object color image and shadow image. By repeatedly performing the separation into the object color image and the shadow image until the predetermined end condition is satisfied, the separation into the object color image and the shadow image can be performed with a higher accuracy, and more properly separated object color image and the shadow image can be output.

As for the predetermined end condition, for example, the number of repetitions can be set in advance, and in a case where the number of repetitions reaches the set number, it can be determined that the predetermined end condition is satisfied.

### <8. Object Color-Shadow Separation Processing of Second Embodiment>

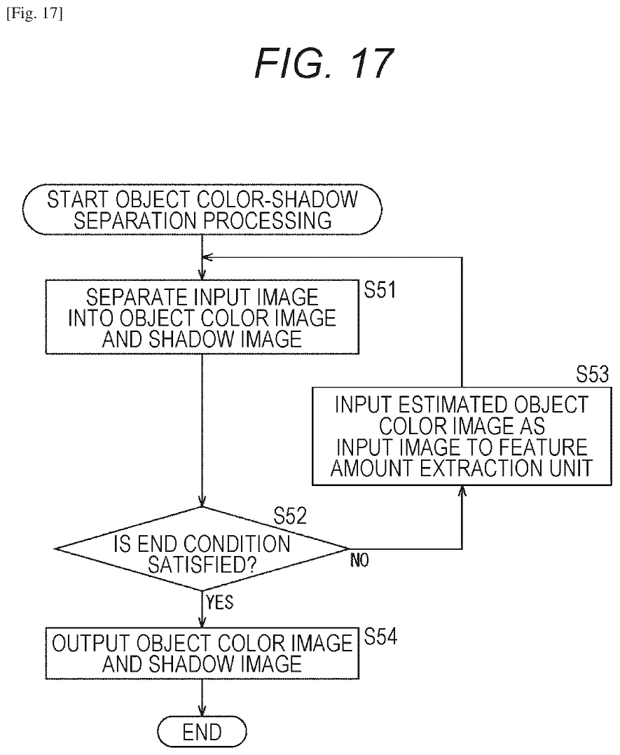

Object color-shadow separation processing performed by the image processing apparatus 1 according to the second embodiment will be described with reference to a flowchart of FIG. 17. The object color-shadow separation processing is started, for example, once the input image is supplied to the image processing apparatus 1.

First, in Step S51, the feature amount extraction unit 11, the object color estimation unit 12, and the shadow estimation unit 13 performs the processing of separating the input image into the object color image and the shadow image. The specific processing in Step S51 corresponds to one separation processing of performing separation into the object color image and the shadow image, and is the same as the object color-shadow separation processing in FIG. 15 in the first embodiment.

In Step S52, the object color estimation unit 12 determines whether or not a preset end condition is satisfied. In a case where it is determined in Step S52 that the preset end condition is not satisfied, the processing proceeds to Step S53, and the object color estimation unit 12 inputs the estimated object color image to the feature amount extraction unit 11 as the input image. After Step S53, the processing returns to Step S51.

On the other hand, in a case where it is determined in Step S52 that the preset end condition is satisfied, the processing proceeds to Step S54, and the object color estimation unit 12 outputs the estimated object color image. Furthermore, in Step S54, the shadow estimation unit 13 outputs the estimated shadow image.

Once the object color image and the shadow image are output from the image processing apparatus 1, the object color-shadow separation processing of FIG. 17 ends.

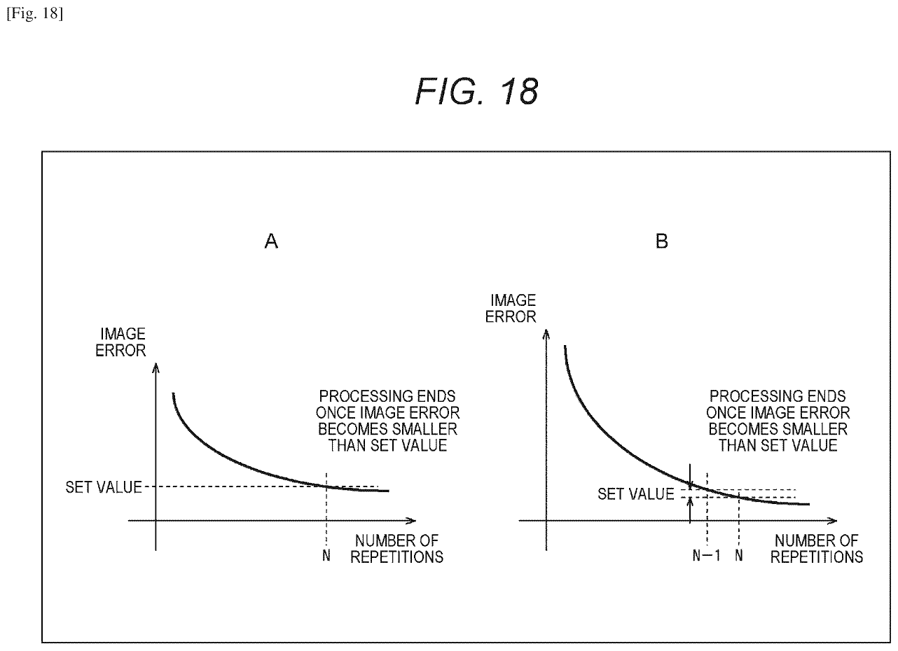

FIG. 18 is a diagram for explaining another example of the end condition.

For example, as illustrated in A of FIG. 18, it is possible to set an end condition that an image error calculated by a root mean square error (RMSE) or the like between the input image input to the feature amount extraction unit 11 and the object color image estimated by the object color estimation unit 12 is smaller than a predetermined set value. In a case where the image error becomes smaller than the predetermined set value, it is determined that the end condition is satisfied, the object color estimation unit 12 outputs the estimated object color image, and the shadow estimation unit 13 outputs the estimated shadow image.

Alternatively, as illustrated in B of FIG. 18, assuming that the object color estimation unit 12 has performed the processing of estimating the object color image Q times (Q>1), it is possible to set an end condition that a difference between an image error between the (Q-1)-th input image and the object color image output by the object color estimation unit 12 and an image error between the Q-th input image and the object color image output by the object color estimation unit 12 is smaller than a predetermined set value. In a case where the difference between the image errors becomes smaller than the predetermined set value, it is determined that the end condition is satisfied, the object color estimation unit 12 outputs the estimated object color image, and the shadow estimation unit 13 outputs the estimated shadow image.

### <9. Third Embodiment of Image Processing Apparatus>

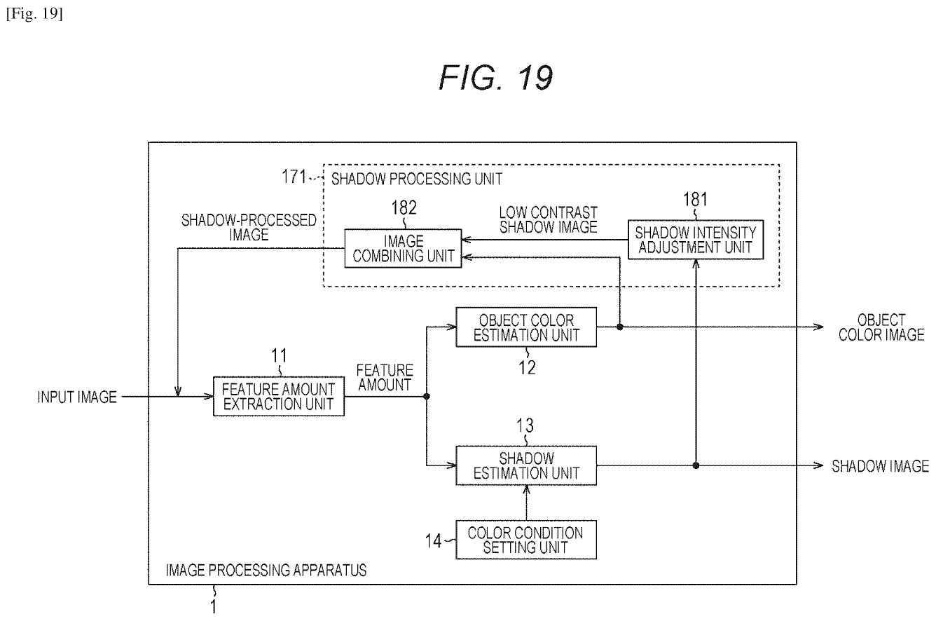

FIG. 19 is a block diagram illustrating an example of a configuration of a third embodiment of an image processing apparatus of the present disclosure.

An image processing apparatus 1 according to the third embodiment illustrated in FIG. 19 is different from the above-described first embodiment in that a shadow processing unit 171 is newly added, and the other configurations are common. The shadow processing unit 171 includes a shadow intensity adjustment unit 181 and an image combining unit 182.

The shadow image estimated by the shadow estimation unit 13 is supplied to the shadow intensity adjustment unit 181. The shadow intensity adjustment unit 181 performs shadow intensity adjustment processing of adjusting a shadow intensity of the shadow image. Specifically, the shadow intensity adjustment unit 181 performs low contrast processing of reducing a contrast of the shadow by performing expo-nentiation conversion on a luminance value of the supplied shadow image. For example, the shadow intensity adjustment unit 181 obtains a luminance value after the low contrast processing by [luminance value]^{p} with a power p=0.9 or the like, and generates a low contrast shadow image. The shadow intensity adjustment unit 181 supplies the generated low contrast shadow image to the image combining unit 182.

The low contrast shadow image is supplied from the shadow intensity adjustment unit 181 to the image combining unit 182, and the object color image estimated by the object color estimation unit 12 is supplied to the image combining unit 182. The image combining unit 182 generates an image in which a shadow effect has been weakened as compared with the input image (hereinafter, referred to as a shadow-processed image) by multiplying corresponding pixels of the low contrast shadow image and the object color image. The generated shadow-processed image is input to the feature amount extraction unit 11 again as the input image. Similarly to the second embodiment, the processing of inputting the shadow-processed image with the adjusted shadow intensity to the feature amount extraction unit 11 as the input image is repeatedly performed until it is determined that a predetermined end condition is satisfied.

With the image processing apparatus 1 according to the third embodiment, the amount of change between the input image and the object color image is reduced, and it is thus possible to expect similar effects as those of the second embodiment in which recursive processing is performed. That is, separation into the object color image and the shadow image can be performed with a higher precision, and more properly separated object color image and shadow image can be output.

### <10. Object Color-Shadow Separation Processing of Third Embodiment>

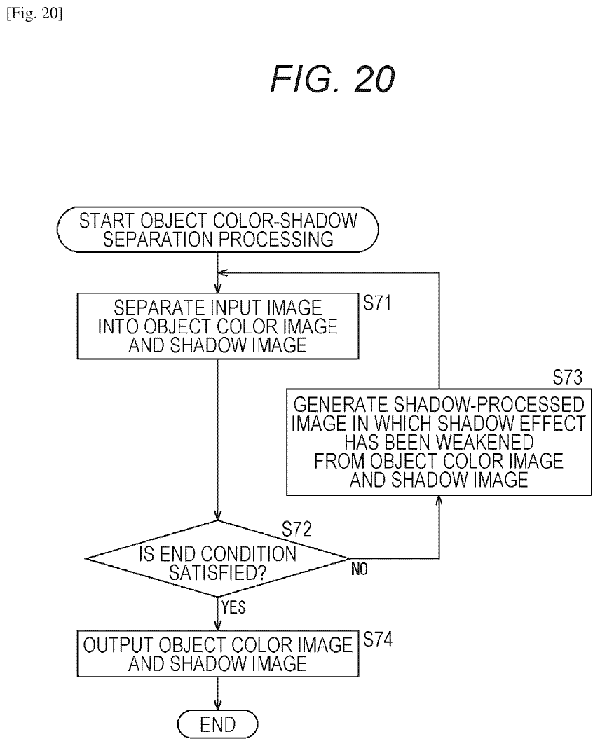

Object color-shadow separation processing performed by the image processing apparatus 1 according to the third embodiment will be described with reference to a flowchart of FIG. 20. The object color-shadow separation processing is started, for example, once the input image is supplied to the image processing apparatus 1.

First, in Step S71, the feature amount extraction unit 11, the object color estimation unit 12, and the shadow estimation unit 13 performs the processing of separating the input image into the object color image and the shadow image. The specific processing in Step S71 corresponds to one separation processing of performing separation into the object color image and the shadow image, and is the same as the object color-shadow separation processing in FIG. 15 in the first embodiment. However, the difference is that the shadow image estimated by the shadow estimation unit 13 is supplied to the shadow intensity adjustment unit 181, and the object color image estimated by the object color estimation unit 12 is supplied to the image combining unit 182.

In Step S72, the object color estimation unit 12 determines whether or not a preset end condition is satisfied. In a case where it is determined in Step S72 that the preset end condition is not satisfied, the processing proceeds to Step S73.

In Step S73, the shadow processing unit 171 generates the shadow-processed image in which the shadow effect has been weakened as compared with the input image from the estimated object color image and shadow image, and inputs the shadow-processed image to the feature amount extraction unit 11 as the input image. More specifically, the shadow intensity adjustment unit 181 generates the low contrast shadow image by performing the shadow intensity adjustment processing on the shadow image estimated by the shadow estimation unit 13, and supplies the low contrast shadow image to the image combining unit 182. The image combining unit 182 generates the shadow-processed image by multiplying the low contrast shadow image by the corresponding pixels of the object color image. The shadow-processed image generated by the image combining unit 182 is input to the feature amount extraction unit 11 as the input image, and the processing returns to Step S71.

On the other hand, in a case where it is determined in Step S72 that the preset end condition is satisfied, the processing proceeds to Step S74, and the object color estimation unit 12 outputs the estimated object color image. Furthermore, in Step S74, the shadow estimation unit 13 outputs the estimated shadow image.

Once the object color image and the shadow image are output from the image processing apparatus 1, the object color-shadow separation processing of FIG. 20 ends.

### <Example of Configuration of Cascade Structure>

The image processing apparatus 1 according to the third embodiment illustrated in FIG. 19 includes one feature amount extraction unit 11, one object color estimation unit 12, and one shadow estimation unit 13, and is configured to input again the object color image and the shadow image estimated by the object color estimation unit 12 and the shadow estimation unit 13 to the same feature amount extraction unit 11 to perform recursive processing.

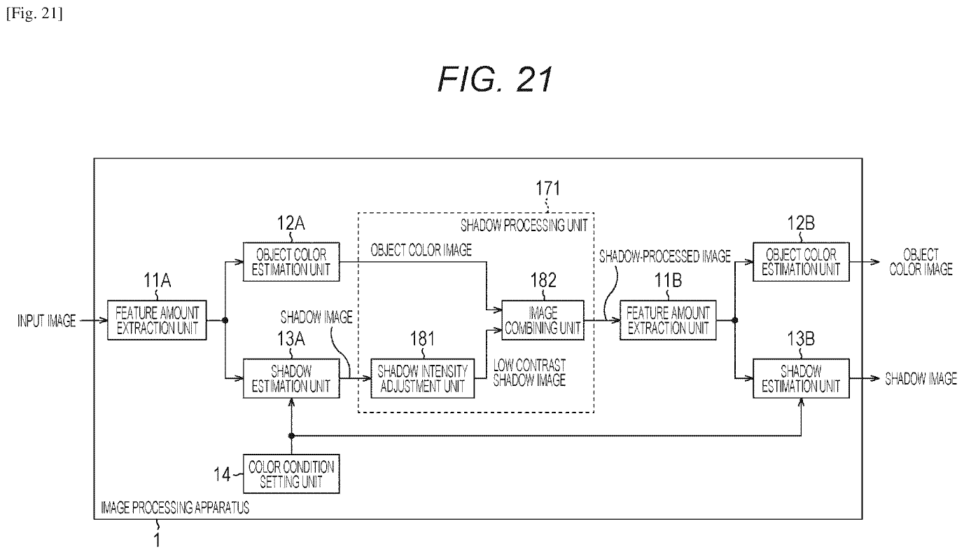

However, as illustrated in FIG. 21, a configuration in which the feature amount extraction unit 11, the object color estimation unit 12, and the shadow estimation unit 13 are provided in two stages, and estimation results of a feature amount extraction unit 11A, an object color estimation unit 12A, and a shadow estimation unit 13A in the preceding stage are input to a feature amount extraction unit 11B, an object color estimation unit 12B, and a shadow estimation unit 13B in the subsequent stage, and the object color-shadow separation processing is repeatedly performed may be adopted. The image processing apparatus 1 of FIG. 21 has a configuration in which the shadow processing unit 171 is provided between the feature amount extraction unit 11A, the object color estimation unit 12A, and the shadow estimation unit 13A in the preceding stage and the feature amount extraction unit 11B, the object color estimation unit 12B, and the shadow estimation unit 13B in the subsequent stage. The image processing apparatus 1 is an example having a two-stage cascade structure, but it is a matter of course that the image processing apparatus 1 may have a cascade structure with a three or more stages.

### <11. Example of Configuration of Learning Apparatus>

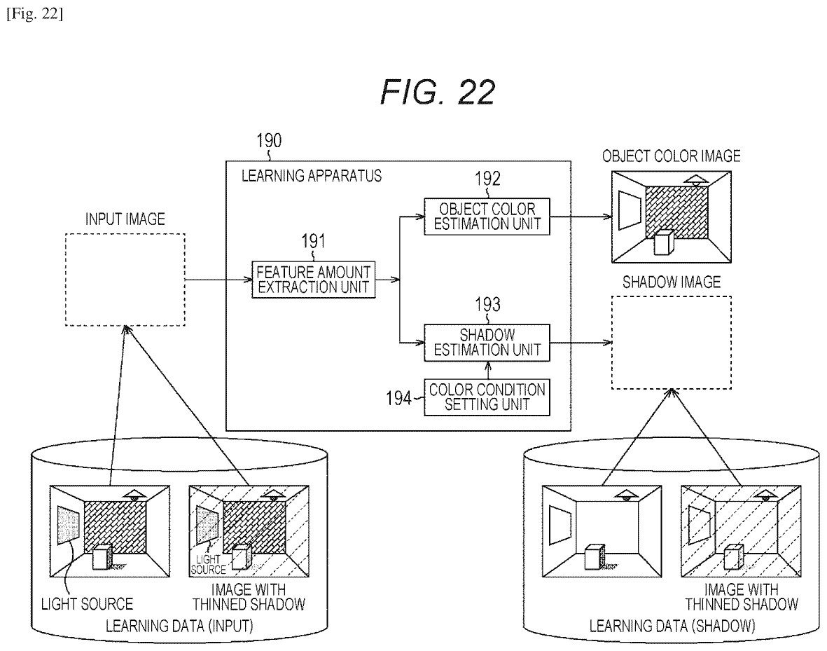

FIG. 22 is a block diagram illustrating an example of a configuration of the learning apparatus that learns a parameter of the CNN predictor.

A learning apparatus 190 illustrated in FIG. 22 includes a feature amount extraction unit 191, an object color estimation unit 192, a shadow estimation unit 193, and a color condition setting unit 194. Detailed configurations of the feature amount extraction unit 191, the object color estimation unit 192, the shadow estimation unit 193, and the color condition setting unit 194 are similar to those of the feature amount extraction unit 11, the object color estimation unit 12, the shadow estimation unit 13, and the color condition setting unit 14, respectively, and thus a detailed description thereof will be omitted.

In the learning processing performed by the learning apparatus 190, an input image, and a large number of object color images and shadow images as training images corresponding to the input image are prepared as learning data, and the parameter of the CNN predictor is calculated by error back propagation.

In a case of performing separation into the object color image and the shadow image with a high precision by recursion as in the image processing apparatus 1 according to the second embodiment illustrated in FIG. 16 and the image processing apparatus 1 according to the third embodiment illustrated in FIG. 19, the shadow processing unit 171 described above is also used at the time of learning, and a set of an input image obtained by thinning the shadow in the input image prepared in advance, an object color image with a reduced reflectance, and a shadow image with a thinned shadow is further added as the learning data, so that it is possible to calculate a parameter for performing separation into the object color image and the shadow image with a higher precision.

### <12. Fourth Embodiment of Image Processing Apparatus>

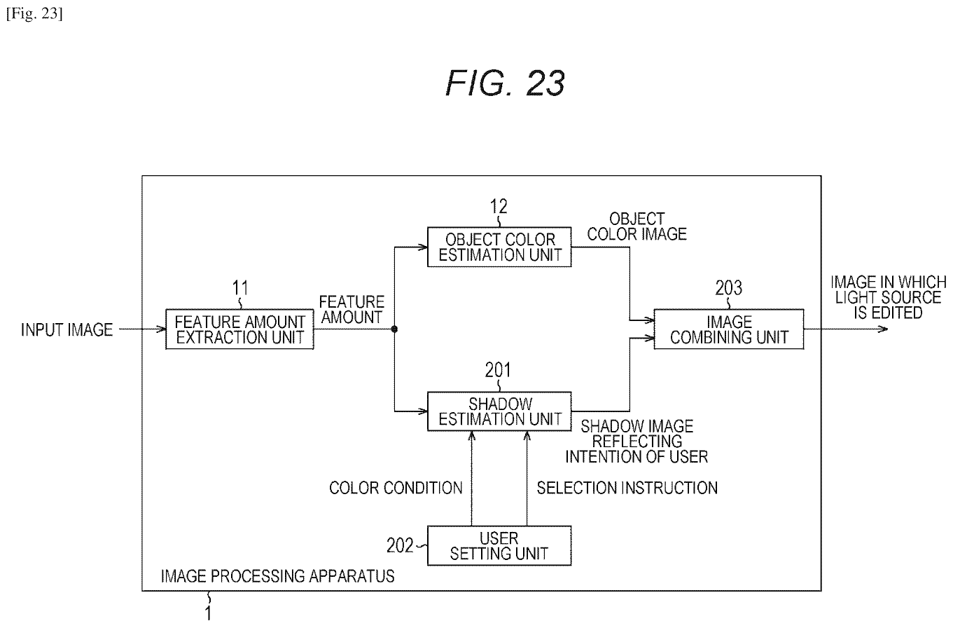

FIG. 23 is a block diagram illustrating an example of a configuration of a fourth embodiment of an image processing apparatus of the present disclosure.

An image processing apparatus 1 according to the fourth embodiment illustrated in FIG. 23 includes a feature amount extraction unit 11, an object color estimation unit 12, a shadow estimation unit 201, a user setting unit 202, and an image combining unit 203.

The image processing apparatus 1 according to the fourth embodiment is different from the first embodiment described above in that the shadow estimation unit 13 and the color condition setting unit 14 of the first embodiment are replaced with the shadow estimation unit 201 and the user setting unit 202, and the image combining unit 203 is newly added.

Similarly to the shadow estimation unit 13 of the first embodiment, the shadow estimation unit 201 generates, as intermediate products, shadow images of first to N-th colors corresponding to first to N-th base colors supplied as color conditions from the user setting unit 202. The shadow estimation unit 13 according to the first embodiment generates the shadow image by combining all the shadow images of the first to N-th colors generated as the intermediate products, but the shadow estimation unit 201 selects at least one of the shadow images of the first to N-th colors according to a selection instruction from the user setting unit 202. The shadow estimation unit 201 generates a shadow image reflecting an intention of the user by using only the selected image among the shadow images of the first to N-th colors generated as the intermediate products, and supplies the generated shadow image to the image combining unit 203.

The user setting unit 202 sets the color condition for the shadow estimation unit 201, similarly to the first embodiment. Furthermore, the user setting unit 202 receives, from the user, a selection instruction to select some of the shadow images of the first to N-th colors generated as the intermediate products in the shadow estimation unit 201, and supplies the selection instruction to the shadow estimation unit 201.

The image combining unit 203 generates an image in which the light source is edited by multiplying an object color image supplied from the object color estimation unit 12 by corresponding pixels of the shadow image reflecting the intention of the user supplied from the shadow estimation unit 201. The generated image is output to the outside of the image processing apparatus 1.

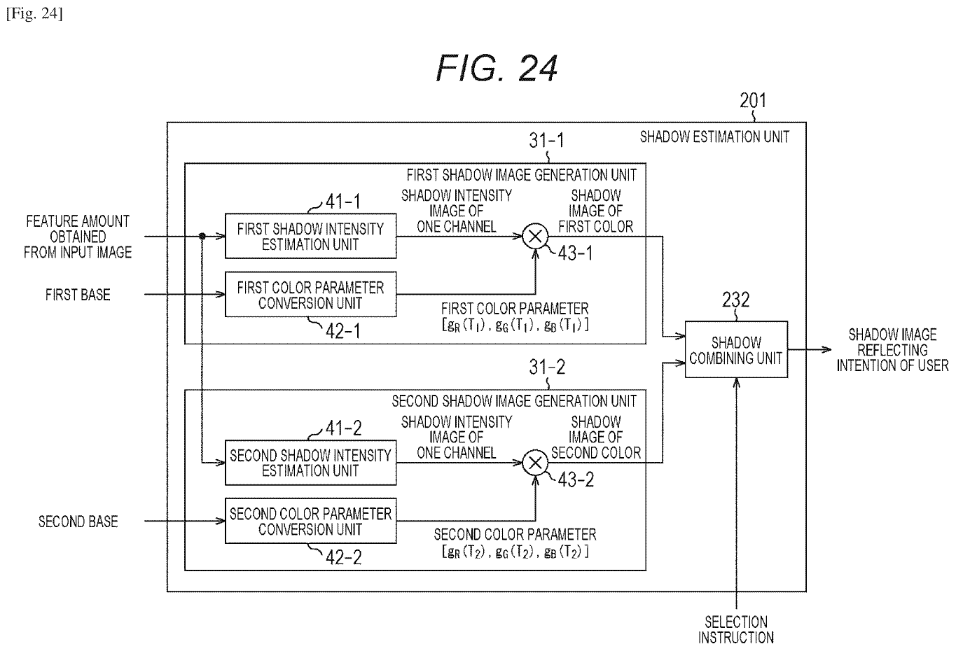

FIG. 24 is a block diagram illustrating a detailed configuration example of the shadow estimation unit 201 of FIG. 23. However, the shadow estimation unit 201 of FIG. 24 corresponds to an example of a configuration in which the base number N is two (N=2) for the sake of simplicity.

The shadow estimation unit 201 has a configuration in common with the shadow estimation unit 13 of FIG. 4 except that the shadow combining unit 232 is used instead of the shadow combining unit 32 unlike the shadow estimation unit 13 of FIG. 4 in which the base number N is two in the first embodiment.

The user setting unit 202 supplies, to the shadow combining unit 232, a selection instruction indicating which one of a shadow image of a first color supplied from a first shadow image generation unit 31-1 and a shadow image of a second color supplied from a second shadow image generation unit 31-2 is to be selected.

According to the selection instruction from the user setting unit 202, the shadow combining unit 232 selects one of the shadow image of the first color and the shadow image of the second color, and supplies the selected one to the image combining unit 203 (FIG. 23).

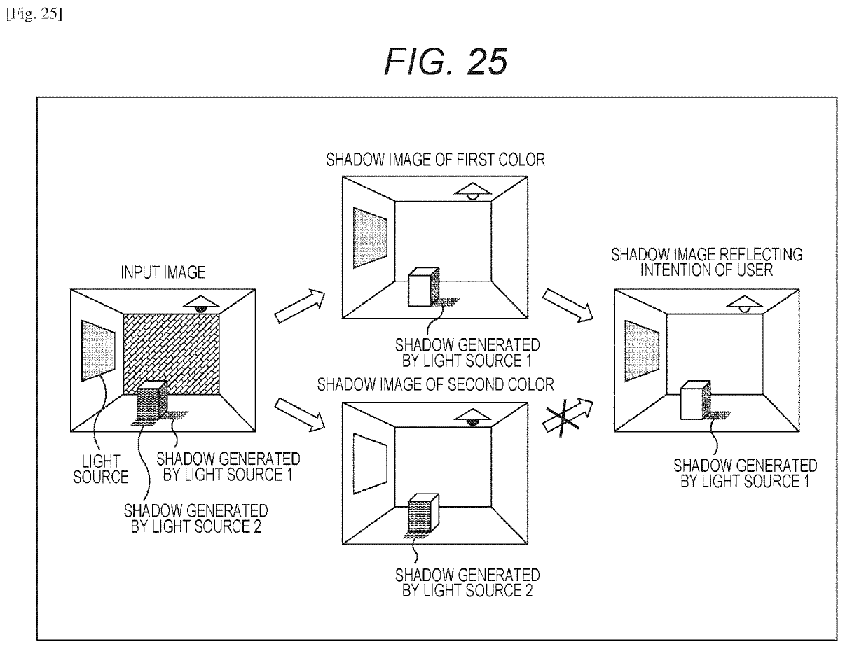

FIG. 25 is a diagram for explaining processing performed by the shadow estimation unit 201.

The input image includes shadows by a light source 1 and a light source 2. The first shadow image generation unit 31-1 generates the shadow image of the first color, which is an image including the shadow by the light source 1, on the basis of the feature amount obtained from the input image. The second shadow image generation unit 31-2 generates the shadow image of the second color, which is an image including the shadow by the light source 2, on the basis of the feature amount obtained from the input image.

In a case where the user desires to generate an image excluding the influence of the light source 2, the user gives, to the user setting unit 202, an instruction to select the shadow image of the first color and delete the shadow image of the second color. With this operation, the shadow combining unit 232 selects and outputs only the shadow image of the first color as the shadow image reflecting the intention of the user.

Note that, since FIGS. 24 and 25 are examples in which the base number N is two, only one of the shadow image of the first color and the shadow image of the second color is selected, the other is not selected, and the selected one is output. However, in a case where the base number N is three or more and shadow images of a plurality of colors are selected, the shadow combining unit 232 combines and outputs the shadow images of the plurality of selected colors as in the shadow combining unit 32 of the first embodiment.

Since the image combining unit 203 of FIG. 23 combines the object color image supplied from the object color estimation unit 12 with the shadow image excluding the influence of the light source 2, the image output from the image processing apparatus 1 is an image illuminated only with the first base color excluding the influence of the light source 2.

With the image processing apparatus 1 according to the fourth embodiment, the shadow images of the first to N-th colors, which have been regarded as the intermediate products in the above-described first embodiment, can be selected, so that the user can perform light source separation and light source editing.

### <13. Example of Configuration of Computer>

A series of processes performed by the image processing apparatus 1 and the learning apparatus 190 described above can be executed by hardware or software. In a case where the series of pieces of processing is performed by software, a program con-stituting the software is installed in a computer. Here, the computer includes a micro-computer incorporated in dedicated hardware, a general-purpose personal computer capable of executing various functions by installing various programs, and the like, for example.

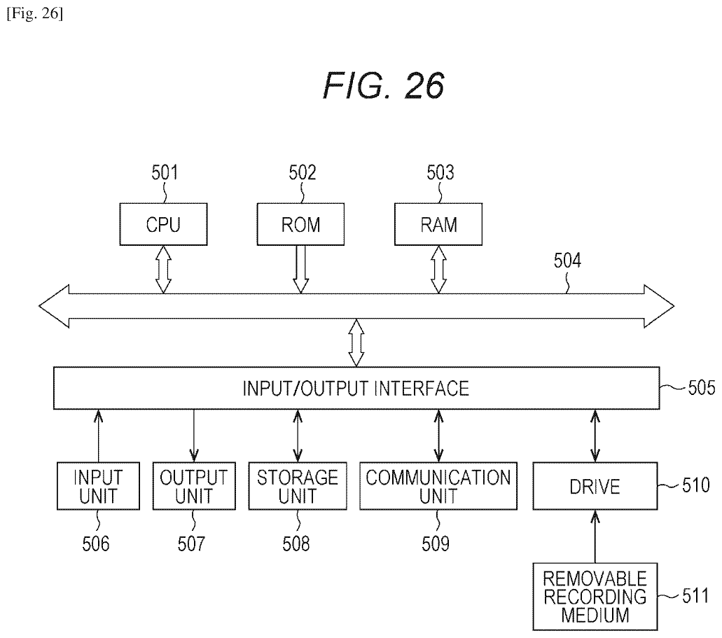

FIG. 26 is a block diagram illustrating an example of a configuration of hardware of a computer executing the series of processing described above by using a program.

In the computer, a central processing unit (CPU) 501, a read only memory (ROM) 502, and a random access memory (RAM) 503 are connected to one another by a bus 504.

Moreover, an input/output interface 505 is connected to the bus 504. An input unit 506, an output unit 507, a storage unit 508, a communication unit 509, and a drive 510 are connected to the input/output interface 505.

The input unit 506 includes a keyboard, a mouse, a microphone, a touch panel, an input terminal, and the like. The output unit 507 includes a display, a speaker, an output terminal, and the like. The storage unit 508 includes a hard disk, a RAM disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program stored in the storage unit 508 to the RAM 503 through the input/output interface 505 and the bus 504, and executes the program, such that the series of pieces of processing described above is performed. The RAM 503 also appropriately stores data and the like necessary for the CPU 501 to execute various types of processing.

The program executed by the computer (CPU 501) can be provided by being recorded in the removable recording medium 511 as a package medium or the like, for example. Furthermore, the program can be provided via a wired or wireless transmission medium such as a local area network, the Internet, or digital satellite broadcasting.

In the computer, the program can be installed in the storage unit 508 via the input/output interface 505 by mounting the removable recording medium 511 on the drive 510. Furthermore, the program can be received by the communication unit 509 via a wired or wireless transmission medium and installed in the storage unit 508. In addition, the program can be installed in the ROM 502 or the storage unit 508 in advance.

Note that, in the present specification, the steps described in the flowcharts may be performed not only in series according to the described order, but also in parallel or at necessary timings such as when a call is made, without being necessarily performed in series.

The embodiment of the present disclosure is not limited to those described above, and may be variously changed without departing from the technical gist of the present disclosure.

For example, a mode in which all or some of the plurality of embodiments described above are combined can be adopted.

For example, the technology of the present disclosure can have a configuration of cloud computing in which one function is performed in cooperation by a plurality of apparatuses via a network.

Furthermore, each step described in the above-described flowchart can be performed by one apparatus or can be performed in a distributed manner by a plurality of apparatuses.

Moreover, in a case where a plurality of pieces of processing is included in one step, the plurality of pieces of processing included in the one step can be performed by one apparatus or can be performed in a distributed manner by a plurality of apparatuses.

Note that the effects described in the present specification are merely illustrative and not limitative, and effects other than those described in the present specification may be achieved.

Note that the technology of the present disclosure can have the following configurations.

(1)

An image processing apparatus including:
an object color estimator that estimates an object color image having a color component of an object included in an input image as a pixel value on a basis of a feature amount of the input image; and
a shadow estimator that estimates a shadow image having a shadow component of the input image as a pixel value on a basis of the feature amount of the input image,
in which the shadow estimator estimates the shadow image by limiting a color space that is available by the shadow component of the input image to a color space determined under a predetermined color condition.
   (2)

The image processing apparatus according to (1), in which
N base colors (N>1) are given as the predetermined color condition, and the shadow estimator estimates the shadow image by limiting the color space that is available by the shadow component of the input image to a color space expressed by the N base colors.
   (3)

The image processing apparatus according to (2), in which the shadow estimator includes:
shadow image generators, being the number N in quantity, that each generate a shadow image corresponding to a predetermined base color; and
a shadow combiner that combines the shadow images of the N base colors generated by the N shadow image generators.
   (4)

The image processing apparatus according to (3), in which
a shadow image generator of the shadow image generators includes:
a shadow intensity image estimator that estimates a shadow intensity image on a basis of the feature amount of the input image; and
a color parameter converter that converts the predetermined base color into a color parameter.
   (5)

The image processing apparatus according to (4), in which the shadow image generator includes:
a multiplier that
generates the shadow image by multiplying the shadow intensity image by the color parameter, and
supplies the generated shadow image to the shadow combiner.
   (6)

The image processing apparatus according to any one of (2) to (4), in which the base color is given by a color temperature.

(7)

The image processing apparatus according to any one of (2) to (4), in which the base color is given by xy coordinate values on an xy chromaticity diagram.

(8)

The image processing apparatus according to any one of (2) to (4), in which the base color is given by a color parameter of RGB.

(9)

The image processing apparatus according to (1), in which the color space determined under the predetermined color condition is a space based on a commission on illumination (CIE) daylight model.

(10)

The image processing apparatus according to (9), in which a basis function of the CIE daylight model is given as the predetermined color condition.

(11)

The image processing apparatus according to (10), in which the shadow estimator includes:
a first coefficient image estimator that estimates a first coefficient image storing a coefficient of a first basis function of the CIE daylight model;
a second coefficient image estimator that estimates a second coefficient image storing a coefficient of a second basis function of the CIE daylight model;
a third coefficient image estimator that estimates a third coefficient image storing a coefficient of a third basis function of the CIE daylight model;
a combiner that combines the first to third coefficient images to generate a shadow spectral distribution image; and
a spectral sensitivity applier that convolves the shadow spectral distribution image with spectral sensitivity functions of R, G, and B to convert the shadow spectral distribution image into the shadow image.
   (12)

The image processing apparatus according to (1), in which the predetermined color condition is an imaging time of the input image.

(13)

The image processing apparatus according to (12), in which conversion into a color parameter corresponding to direct light and a color parameter corresponding to global light is made according to the imaging time, and the shadow estimator includes:
a first shadow image generator that generates a shadow image of a first color using the color parameter corresponding to the direct light;
a second shadow image generator that generates a shadow image of a second color using the color parameter corresponding to the global light; and
a shadow combiner that combines the shadow image of the first color and the shadow image of the second color.
   (14)

The image processing apparatus according to any one of (1) to (13), further including a feature amount extraction unit that extracts the feature amount of the input image.

(15)

The image processing apparatus according to (14), in which processing of inputting the object color image estimated by the object color estimator as the input image to the feature amount extractor is repeatedly performed until a predetermined end condition is satisfied.

(16)

The image processing apparatus according to (14), further including a shadow processor that generates a shadow-processed image in which a shadow intensity has been adjusted by using the object color image estimated by the object color estimator and the shadow image estimated by the shadow estimator,
wherein processing of inputting the shadow-processed image as the input image to the feature amount extractor is repeatedly performed until a predetermined end condition is satisfied.
   (17)

The image processing apparatus according to (1), in which the shadow estimator includes:
N shadow image generators (N>1) that each generate a shadow image of a color corresponding to the predetermined color condition; and
a shadow combiner that selects and combines at least one of the shadow images of N colors generated by the N shadow image generators according to a selection instruction from a user, and
a combined image from the shadow combiner and the object color image estimated by the object color estimator are combined.
   (18)

The image processing apparatus according to any one of (1) to (17), in which a convolutional neural network (CNN) predictor using a parameter obtained by learning processing is used for the object color estimator and the shadow estimator.

(19)

An image processing method executed by an image processing apparatus, the image processing method including:
estimating an object color image having a color component of an object included in an input image as a pixel value on the basis of a feature amount of the input image; and
estimating a shadow image having a shadow component of the input image as a pixel value on the basis of the feature amount of the input image,
in which the shadow image is estimated by limiting a color space that is available by the shadow component of the input image to a color space determined under a predetermined color condition.
   (20)

An image processing apparatus including:
processing circuitry; and
a non-transitory computer-readable storage medium storing thereon executable instructions which when executed by the processing circuitry causes the processing circuitry to:
estimate, by a convolutional neural network (CNN) predictor using a parameter obtained by learning processing, an object color image having a color component of an object included in an input image as a pixel value on a basis of a feature amount of the input image; and
estimate, by the CNN predictor, a shadow image having a shadow component of the input image as a pixel value on a basis of the feature amount of the input image, wherein the CNN predictor estimates the shadow image by limiting a color space that is available by the shadow component of the input image to a color space determined under a predetermined color condition.
   (21)

The image processing apparatus according to (20), in which the learning processing includes using object color images and shadow images as training images.

### REFERENCE SIGNS LIST

1 Image processing apparatus
11 Feature amount extraction unit
12 Object color estimation unit
13 Shadow estimation unit
14 Color condition setting unit
31 Shadow image generation unit
31-1 to 31-N First to N-th shadow image generation units
32 Shadow combining unit
41-1 to 41-N First to N-th shadow intensity estimation units
42-1 to 42-N First to N-th color parameter conversion units
43-1 to 43-N Multiplication unit
61 Image dataset
81-1 to 81-3 First to third coefficient image estimation units
91 Spectrum combining unit
92 Camera spectral sensitivity applying unit
101 Color parameter conversion unit
101-1 First color parameter conversion unit
101-2 Second color parameter conversion unit
171 Shadow processing unit
181 Shadow intensity adjustment unit
182 Image combining unit
190 Learning apparatus
191 Feature amount extraction unit
192 Object color estimation unit
193 Shadow estimation unit
194 Color condition setting unit
201 Shadow estimation unit
202 User setting unit
203 Image combining unit
232 Shadow combining unit
501 CPU
502 ROM
503 RAM
506 Input unit
507 Output unit
508 Storage unit
509 Communication unit
510 Drive

1. An image processing apparatus comprising:
an object color estimator that estimates an object color image having a color component of an object included in an input image as a pixel value on a basis of a feature amount of the input image; and
a shadow estimator that estimates a shadow image having a shadow component of the input image as a pixel value on a basis of the feature amount of the input image,
wherein the shadow estimator estimates the shadow image by limiting a color space that is available by the shadow component of the input image to a color space determined under a predetermined color condition.

2. The image processing apparatus according to claim 1, wherein N base colors (N>1) are given as the predetermined color condition, and the shadow estimator estimates the shadow image by limiting the color space that is available by the shadow component of the input image to a color space expressed by the N base colors.

3. The image processing apparatus according to claim 2, wherein the shadow estimator includes:
shadow image generators, being the number N in quantity, that each generate a shadow image corresponding to a predetermined base color; and
a shadow combiner that combines the shadow images of the N base colors generated by the N shadow image generators.

4. The image processing apparatus according to claim 3, wherein a shadow image generator of the shadow image generators includes:
a shadow intensity image estimator that estimates a shadow intensity image on a basis of the feature amount of the input image; and
a color parameter converter that converts the predetermined base color into a color parameter.

5. The image processing apparatus according to claim 4, wherein the shadow image generator includes:
a multiplier that
generates the shadow image by multiplying the shadow intensity image by the color parameter, and
supplies the generated shadow image to the shadow combiner.

6. The image processing apparatus according to claim 2, wherein the base color is given by a color temperature.

7. The image processing apparatus according to claim 2, wherein the base color is given by xy coordinate values on an xy chromaticity diagram.

8. The image processing apparatus according to claim 2, wherein the base color is given by a color parameter of RGB.

9. The image processing apparatus according to claim 1, wherein the color space determined under the predetermined color condition is a space based on a commission on illumination (CIE) daylight model.

10. The image processing apparatus according to claim 9, wherein a basis function of the CIE daylight model is given as the predetermined color condition.

11. The image processing apparatus according to claim 10, wherein the shadow estimator includes:
a first coefficient image estimator that estimates a first coefficient image storing a coefficient of a first basis function of the CIE daylight model;
a second coefficient image estimator that estimates a second coefficient image storing a coefficient of a second basis function of the CIE daylight model;
a third coefficient image estimator that estimates a third coefficient image storing a coefficient of a third basis function of the CIE daylight model;
a combiner that combines the first to third coefficient images to generate a shadow spectral distribution image; and
a spectral sensitivity applier that convolves the shadow spectral distribution image with spectral sensitivity functions of R, G, and B to convert the shadow spectral distribution image into the shadow image.

12. The image processing apparatus according to claim 1, wherein the predetermined color condition is an imaging time of the input image.

13. The image processing apparatus according to claim 12, wherein conversion into a color parameter corresponding to direct light and a color parameter corresponding to global light is made according to the imaging time, and
the shadow estimator includes:
a first shadow image generator that generates a shadow image of a first color using the color parameter corresponding to the direct light;
a second shadow image generator that generates a shadow image of a second color using the color parameter corresponding to the global light; and
a shadow combiner that combines the shadow image of the first color and the shadow image of the second color.

14. The image processing apparatus according to claim 1, further comprising a feature amount extractor that extracts the feature amount of the input image.

15. The image processing apparatus according to claim 14, wherein processing of inputting the object color image estimated by the object color estimator as the input image to the feature amount extractor is repeatedly performed until a predetermined end condition is satisfied.

16. The image processing apparatus according to claim 14, further comprising a shadow processor that generates a shadow-processed image in which a shadow intensity has been adjusted by using the object color image estimated by the object color estimator and the shadow image estimated by the shadow estimator,
wherein processing of inputting the shadow-processed image as the input image to the feature amount extractor is repeatedly performed until a predetermined end condition is satisfied.

17. The image processing apparatus according to claim 1, wherein the shadow estimator includes:
N shadow image generators (N>1) that each generate a shadow image of a color corresponding to the predetermined color condition; and
a shadow combiner that selects and combines at least one of the shadow images of N colors generated by the N shadow image generators according to a selection instruction from a user, and a combined image from the shadow combiner and the object color image estimated by the object color estimator are combined.

18. The image processing apparatus according to claim 1, wherein a convolutional neural network (CNN) predictor using a parameter obtained by learning processing is used for the object color estimator and the shadow estimator.

19. An image processing method executed by an image processing apparatus, the image processing method comprising:
estimating an object color image having a color component of an object included in an input image as a pixel value on a basis of a feature amount of the input image; and
estimating a shadow image having a shadow component of the input image as a pixel value on a basis of the feature amount of the input image,
wherein the shadow image is estimated by limiting a color space that is available by the shadow component of the input image to a color space determined under a predetermined color condition.

20. An image processing apparatus comprising:
processing circuitry; and
a non-transitory computer-readable storage medium storing thereon executable instructions which when executed by the processing circuitry causes the processing circuitry to:
estimate, by a convolutional neural network (CNN) predictor using a parameter obtained by learning processing, an object color image having a color component of an object included in an input image as a pixel value on a basis of a feature amount of the input image; and
estimate, by the CNN predictor, a shadow image having a shadow component of the input image as a pixel value on a basis of the feature amount of the input image,
wherein the CNN predictor estimates the shadow image by limiting a color space that is available by the shadow component of the input image to a color space determined under a predetermined color condition.

21. The image processing apparatus according to claim 20, wherein the learning processing includes using object color images and shadow images as training images.
